(19) United States
(12) Patent Application Publication
(10) Pub. No.: US 2025/0279406 A1
(43) Pub. Date: Sep. 4, 2025

(54) METHOD OF MANUFACTURING ELECTRODE FOR ELECTROCHEMICAL ELEMENT, ELECTRODE FOR ELECTROCHEMICAL ELEMENT, ELECTROCHEMICAL ELEMENT, ELECTRIC DEVICE, AND MOBILE OBJECT

(71) Applicants: Muxin LI, Kanagawa (JP); Yuji SONE, Kanagawa (JP); Soh NOGUCHI, Kanagawa (JP); Ryuji HIGASHI, Kanagawa (JP)

(72) Inventors: Muxin LI, Kanagawa (JP); Yuji SONE, Kanagawa (JP); Soh NOGUCHI, Kanagawa (JP); Ryuji HIGASHI, Kanagawa (JP)

(21) Appl. No.: 19/063,384

(22) Filed: Feb. 26, 2025

(30) Foreign Application Priority Data
Feb. 29, 2024 (JP) 2024-029431

(51) Int. Cl. H01M 4/04; B41M 3/00; B41M 5/00; B60L 50/60; B60R 16/033; H01G 11/26; H01G 11/50; H01G 11/56; H01G 11/86; H01M 4/62; H01M 10/0585

(52) U.S. Cl. CPC H01M 4/0419; B41M 3/008; B41M 5/0047; H01G 11/26; H01G 11/50; H01G 11/86; H01M 4/628; H01M 10/0585; B60L 50/60; B60R 16/033; H01G 11/56; H01M 2220/20

(57) ABSTRACT

A method of manufacturing an electrode for an electrochemical element includes applying a first liquid composition onto an electrode composite layer having a rough structure by inkjetting in an amount of 0.34 to 10 mg/cm² per application to form a first solid electrolyte layer comprising a solid electrolyte, to manufacture the electrode including: a substrate; the electrode composite layer disposed on the substrate, comprising an active material; and the first solid electrolyte layer, wherein the liquid composition comprises the solid electrolyte and a dispersion medium and has a viscosity of 4 to 20 mPa·s.

### CROSS-REFERENCE TO RELATED APPLICATIONS

This patent application is based on and claims priority pursuant to 35 U.S.C. § 119 to Japanese Patent Application No. 2024-029431, filed on Feb. 29, 2024, in the Japan Patent Office, the entire disclosure of which is hereby incorporated by reference herein.

### BACKGROUND

### Technical Field

The present disclosure is related to a method of manufacturing an electrode for electrochemical element, an electrode for electrochemical element, an electrochemical element, an electric device, and a mobile object.

### Description of the Related Art

Lithium-ion secondary batteries, lithium-ion capacitors, electric double-layer capacitors, redox capacitors, and other electrochemical devices are widely used in electronic devices, electric vehicles, and other applications. In particular, the demand for automotive electrochemical devices is expected to grow against the backdrop of the recent increasing need for environmentally friendly solutions. Against this backdrop, there is a growing demand for improved safety and higher energy density in electrochemical devices. Efforts to commercialize electrochemical devices that replace conventional liquid electrolytes with solid electrolytes are actively underway.

### SUMMARY

According to embodiments of the present disclosure, a method of manufacturing an electrode for an electrochemical element is provided which includes applying a first liquid composition onto an electrode composite layer having a rough structure by inkjetting in an amount of 0.34 to 10 mg/cm² per application to form a first solid electrolyte layer comprising a solid electrolyte, to manufacture the electrode including: a substrate; the electrode composite layer disposed on the substrate, comprising an active material; and the first solid electrolyte layer, wherein the liquid composition comprises the solid electrolyte and a dispersion medium and has a viscosity of 4 to 20 mPa·s.

As another aspect of embodiments of the present disclosure, an electrode for an electrochemical element is provided which includes an electrode including; a substrate; and an electrode composite layer on the substrate, the electrode composite layer comprising an active material; and a solid electrolyte layer on the electrode composite layer, wherein the electrode composite layer has a convex portion with at least 5 μm, and the solid electrolyte layer has a ratio (A/B) of 0.8 to 1.2, where A represents an average thickness of a convex portion of the solid electrolyte layer and an average thickness of a concave portion of the solid electrolyte layer.

As another aspect of embodiments of the present disclosure, an electrochemical element is provided which includes the electrode mentioned above.

As another aspect of embodiments of the present disclosure, an electric device includes the electrochemical element mentioned above.

As another aspect of embodiments of the present disclosure, a mobile object is provided which includes the electrochemical element mentioned above.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1A is a schematic diagram illustrating a cross sectional view of an electrode laminate according to the present disclosure;

FIG. 1B is a schematic diagram illustrating a cross sectional view of an electrode laminate according to the present disclosure;

FIG. 1C is a schematic diagram illustrating a cross sectional view of an electrode laminate according to the present disclosure;

FIG. 2A is a schematic diagram illustrating a cross sectional view of an electrode laminate according to the present disclosure;

FIG. 2B is a schematic diagram illustrating a cross sectional view of an electrode laminate according to the present disclosure;

FIG. 3 is a schematic diagram illustrating a top view of a device for manufacturing an electrode for electrochemical element according to the present disclosure;

FIG. 4 is a schematic diagram illustrating a top view of a device for manufacturing an electrode for electrochemical element according to the present disclosure;

FIG. 5 is a schematic diagram illustrating a top view of a device for manufacturing an electrode for electrochemical element according to the present disclosure;

FIG. 6A is a schematic diagram illustrating a cross sectional view (part 1) of a positional relationship between the insulating layer and electrode composite layer in an electrode for electrochemical element according to the present disclosure;

FIG. 6B is a schematic diagram illustrating a cross sectional view (part 2) of a positional relationship between the insulating layer and electrode composite layer in an electrode for electrochemical element according to the present disclosure;

FIG. 6C is a schematic diagram illustrating a cross sectional view (part 3) of a positional relationship between the insulating layer and electrode composite layer in an electrode for electrochemical element according to the present disclosure;

FIG. 6D is a schematic diagram illustrating a cross sectional view (part 4) of a positional relationship between the insulating layer and electrode composite layer in an electrode for electrochemical element according to the present disclosure;

FIG. 7 is a schematic diagram illustrating a top view of a positional relationship between the insulating layer and electrode composite layer in an electrode for electrochemical element according to the present disclosure;

FIG. 8A is a schematic diagram illustrating a cross sectional view (part 1) of a relationship of the average thickness between the insulating layer and electrode composite layer in an electrode for electrochemical element according to the present disclosure;

FIG. 8B is a schematic diagram illustrating a cross sectional view (part 2) of a relationship of the average thickness between the insulating layer and electrode composite layer in an electrode for electrochemical element according to the present disclosure;

FIG. 8C is a schematic diagram illustrating a cross sectional view (part 3) of a relationship of the average thickness between the insulating layer and electrode composite layer in an electrode for electrochemical element according to the present disclosure;

FIG. 9 is a schematic diagram illustrating an example of a device (liquid discharging device) for manufacturing an insulating layer to execute the method of manufacturing the electrode laminate according to the present disclosure;

FIG. 10 is a schematic diagram illustrating an example of a device (liquid discharging device) for manufacturing an insulating layer to execute the method of manufacturing the electrode laminate according to the present disclosure;

FIG. 11 is a schematic diagram illustrating a method of manufacturing an electrode for electrochemical element according to the present disclosure;

FIG. 12 is a schematic diagram illustrating an example of a device (liquid discharging device) for manufacturing an insulating layer to execute the method of manufacturing the electrode laminate according to the present disclosure;

FIG. 13 is a diagram illustrating a configuration of an example of the printing unit employing an inkjet method and transfer method as the liquid composition applying device in a device for manufacturing insulating layers according to the present disclosure;

FIG. 14 is a diagram illustrating a configuration of an example of the printing unit employing an inkjet method and transfer method as the liquid composition applying device in a device for manufacturing insulating layers according to the present disclosure;

FIG. 15 is a schematic diagram illustrating an electrochemical element according to the present disclosure;

FIG. 16 is a schematic diagram illustrating a solid state battery, which is an electrochemical element according to the present disclosure;

FIG. 17 is a schematic diagram illustrating a mobile object, which is an electrochemical element according to the present disclosure;

FIG. 18 is a schematic diagram illustrating a binarized image of an SEM photograph of an electrode composite layer according to one embodiment of the present disclosure; and

FIG. 19 is a schematic diagram illustrating an image of the convex and concave portions of a solid electrode layer.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure. a method of manufacturing an electrode for electrochemical element is provided which produces an electrode for electrochemical element with excellent battery properties.

The method of manufacturing an electrode for electrochemical elements (devices) relating to an embodiment of the present disclosure includes applying a first liquid composition onto an electrode composite layer having a rough structure by inkjetting in an amount of 0.34 to 10 mg/cm² per application to form a first solid electrolyte layer containing a first solid electrolyte, wherein the first liquid composition contains a first solid electrolyte and a dispersion medium and has a viscosity of 4 to 20 mPa·s, the electrode includes a substrate, the electrode composite layer disposed on the substrate, containing an active material, and the first solid electrolyte layer. With this configuration, it is possible to manufacture electrodes for electrochemical devices that exhibit excellent battery features.

It has been known that battery performance can be improved by forming a solid electrolyte layer on an electrode composite layer with an uneven surface, rather than a flat electrode layer, to increase the surface area between the electrode composite layer and the solid electrolyte layer. One method of manufacturing electrodes used in electrochemical devices has been proposed in Unexamined Japanese Patent Application Publication No. 2012-022827, which involves applying a solid electrolyte layer onto an electrode composite layer with an uneven surface using the spin coating method. However, with this method, liquid composition tends to accumulate in the recesses of the electrode composite layer, making it difficult to form a uniform solid electrolyte layer. As a result, short circuits may occur in the thinner areas on the protrusions.

Furthermore, the liquid composition flows into the recesses of the electrode composite layer even when a solid electrolyte layer is formed on an electrode composite layer with an uneven surface using an inkjet method, unless the amount of application is appropriate. This makes it similarly difficult to form a uniform film and can lead to short circuits.

A method of manufacturing an electrode for electrochemical elements according to one embodiment of the present disclosure involves applying a liquid composition (first liquid composition) containing a solid electrolyte and a dispersion medium onto an electrode composite layer using an inkjet method to form a first solid electrolyte layer. The application is carried out such that the amount of liquid composition applied in a single application is between 0.34 mg/cm² and 10 mg/cm². This ensures the formation of a solid electrolyte layer with uniform thickness, resulting in an electrode for electrochemical elements that exhibits excellent battery properties, such as input-output properties, without the occurrence of short circuits.

### Method of Manufacturing Electrode for Electrochemical Element and Apparatus for Manufacturing Electrode for Electrochemical Element

The method of manufacturing an electrode for an electrochemical element according to one embodiment of the present disclosure includes forming a solid electrolyte layer and preferably includes forming an electrode composite layer and forming an insulating layer. Additionally, it may include other optional processes.

An apparatus for manufacturing the electrode for electrochemical elements according to one embodiment of the present disclosure includes a solid electrolyte layer forming device and preferably includes an electrode composite layer forming device and an insulating layer forming device. Furthermore, it may include other optional devices.

The method of manufacturing an electrode for electrochemical elements can be suitably implemented using the apparatus for manufacturing an electrode for electrochemical elements. The solid electrolyte layer formation can be suitably implemented using the solid electrolyte layer forming device, the electrode composite layer formation can be suitably implemented using the electrode composite layer forming device, the insulating layer formation can be suitably implemented using the insulating layer forming device, and other processes can be suitably implemented using other devices.

### Solid Electrolyte Layer Formation and Solid Electrolyte Layer Forming Device

The solid electrolyte layer formation involves applying a liquid composition (first liquid composition) for forming a solid electrolyte layer, which contains a solid electrolyte (first solid electrolyte) and a dispersion medium, using an inkjet method. The amount of liquid applied in a single coating is between 0.34 mg/cm² and 10 mg/cm² to form the solid electrolyte layer (first solid electrolyte layer). The inkjet method can be carried out using a liquid discharging device.

A single application amount refers to the mass per unit area of the liquid composition for forming a solid electrolyte layer that is discharged as the inkjet head moves once. Specifically, the mass is calculated by applying the liquid composition for forming the solid electrolyte layer onto the electrode (including the substrate and the electrode composite layer), punching out 10 circular pieces with a radius of 1 cm, and measuring their total mass and the electrode's mass using a balance. The value is determined by subtracting the mass of the electrode from the entire mass.

Additionally, during the solid electrolyte layer formation, it is also possible to form the first solid electrolyte layer with a laminate structure of at least two layers. This is achieved by repeatedly applying the liquid composition for forming the first solid electrolyte layer, containing a solid electrolyte and a dispersion medium, onto the electrode composite layer using an inkjet method, with each of a single application amount between 0.34 mg/cm² and 10 mg/cm².

Furthermore, the solid electrolyte layer formation may also include applying a liquid composition containing another solid electrolyte different from the first solid electrolyte used in the initial (previous) layer to form another solid electrolyte layer. The liquid composition containing a different solid electrolyte is also referred to as a second liquid composition. The solid electrolyte different from the solid electrolyte used in the initial (previous) layer to form another solid electrolyte is also referred to as the second solid electrolyte.

The liquid discharging device includes a storage container and a discharging device that discharges the liquid composition for forming the solid electrolyte layer contained in the storage container using an inkjet head. It may also include other optional components.

### Liquid Composition for Forming Solid Electrolyte Layer

The liquid composition for forming a solid electrolyte layer contains a solid electrolyte and a dispersion medium and may additionally include active materials, binders, dispersants, conductive additives, and other optional components.

### Solid Electrolyte

The solid electrolyte is not particularly limited as long as it exhibits electronic insulation and ionic conductivity and does not react with the dispersion medium. It can be appropriately selected according to a particular application. Examples include, but are not limited to, oxide solid electrolytes and sulfide solid electrolytes. Of these, sulfide solid electrolytes are preferred in terms of their high plasticity, which allows the formation of good interfaces between solid electrolyte particles or between the solid electrolyte and active materials while suppressing degradation of ionic conductivity. Furthermore, to achieve excellent dispersion effects similar to those of active materials, crystalline argyrodite-type sulfide solid electrolytes are more preferable.

Oxide solid electrolytes include compounds that contain oxygen atoms, exhibit ionic conductivity of metals belonging to Group 1 or Group 2 of the periodic table, and possess electronic insulation.

In the present specification, the term “exhibits electronic insulation” refers to a state where the positive electrode and negative electrode do not short-circuit when facing each other via the solid electrolyte layer.

Additionally, the term “exhibits ionic conductivity” refers to a state where, when a potential difference is applied to the positive electrode and negative electrode facing each other via the solid electrolyte layer, only ions move through the layer.

Specific examples of the oxide solid electrolyte include, but are not limited to, LiₓₐLa_{ya}TiO₃ [xa=0.3 to 0.7, ya=0.3 to 0.7] (LLT), Li_{xb}La_{yb}Zr_{zb}Mbb_{mb}O_{nb} (Mbb is at least one element selected from the group of Al, Mg, Ca, Sr, V, Nb, Ta, Ti, Ge, In, and Sn, where xb satisfies 5≤xb≤10, yb satisfies 1≤yb≤4, zb satisfies 1≤zb≤4, mb satisfies 0≤mb≤2, and nb satisfies 5≤nb≤20, Li_{xc}B_{yc}Mcc_{zc}O_{nc}, where Mcc is at least one element selected from the group consisting of C, S, Al, Si, Ga, Ge, In, and Sn, xc satisfies 0≤xc≤5, yc satisfies 0≤yc≤1, zc satisfies 0≤zc≤1, and nc satisfies 0≤nc≤6, Li_{xd}(Al, Ga)_{yd}(Ti, Ge)_{zd}Si_{ad}P_{md}O_{nd}, where sd satisfies 1≤xd≤3, yd satisfies 0≤yd≤1, zd satisfies 0≤zd≤2, ad satisfies 0≤ad≤1, md satisfies 1≤md≤7, nd satisfies 3≤nd≤13, Li(3−2xe)MeeₓₑDeeO, where xe represents a number of from 0 to 0.1, and Mee represents a divalent metallic atom, and Dee represents a halogen atom or a combination of two or more halogen atoms, Li_{xf}Si_{yf}O_{zf}, where xf satisfies 1≤xf≤5, yf satisfies 0≤yf≤3, zf satisfies 1≤zf≤10, Li_{xg}S_{yg}O_{zg}, where 1≤xg≤3, yg satisfies 0≤yg≤2, zg satisfies 1≤zg≤10, Li₃BO₃—Li₂SO₄, Li₂O—B₂O₃—P₂O₅, Li₂O—SiO₂, Li₆BaLa₂Ta₂O₁₂, Li₃PO_{(4-3/2w)}Nw, where w<1, Li_{3.5}Zn_{0.25}GeO₄ having a LISICON (lithium super ionic conductor) type crystal structure, La_{0.55}Li_{0.35}TiO₃ having a perovskite type crystal structure, LiTi₂P₃O₁₂ having NASICON (Natrium super ionic conductor) type crystal structure, Li_{1+gh+yh}(Al,Ga)ₓₕ(Ti,Ge)₂₋ₓₕSi_{yh}P_{3-yh}O₁₂, where xh satisfies 0≤xh≤1 and yh satisfies 0≤yh≤1, and Li₇La₃Zr₂O₁₂ (LLZ) having a garnet type crystal structure.

As an oxide solid electrolyte, phosphorus compounds containing Li, P, and O are also desirable.

Specific examples include, but are not limited to, lithium phosphate (Li₃PO₄), LiPON obtained by partially substituting oxygens of lithium phosphate with nitrogens, and LiPOD1, where D1 represents at least one of Ti, V, Cr, Mn, Fe, Co, Ni, Cu, Zr, Nb, Mo, Ru, Ag, Ta, W, Pt, and Au.

LiA1ON, where A1 is at least one of Si, B, Ge, Al, C, and Ga, can also be preferably used.

Sulfide solid electrolytes can be roughly classified into crystalline sulfide solid electrolytes and glass-based solid electrolytes.

Specific examples of the crystalline sulfide solid electrolytes include, but are not limited to, Li_{9.54}Si_{1.74}P_{1.44}S_{11.7}C_{10.3}, Li_{9.6}P₃S₁₂, Li₉P₃S₉O₃, Li_{9.81}Sn_{0.81}P_{2.19}S₁₂, Li_{9.42}Si_{1.02}P_{2.1}S_{9.96}O_{2.04}, Li₁₀Ge(P₁₋ₓSbₓ)₂S₁₂, where x satisfies 0≤x≤0.15), Li₁₀SnP₂S₁₂, Li_{10.35}[M1₁₋ₓM2ₓ]_{1.35}P_{1.65}S₁₂, where M1 and M2 each, independently represent one of Si, Ge, Sn, As, and S, x satisfies 0≤x≤0.15, Li₁₁Si₂PS₁₂, Li₁₁AlP₂S₁₂, Li_{3.45}Si_{0.45}P_{0.55}S₄, Li₆PS₅X, where X is Cl, Br, or I, Li₅PS₄X₂, where X is Cl, Br, or I, Li_{5.5}PS_{4.5}Cl_{1.5}, Li_{5.35}Ca_{0.1}PS_{4.5}Cl_{1.55}, Li₆₊ₓMₓSb₁₋ₓS₅I, where M is Si, Ge, or Sn, and x satisfied 0≤x≤1, Li₇P₂S₈I, γ-Li₃PS₄, Li₄MS₄, where M is Ge, Sn, or As), Li₄₋ₓSn₁₋ₓSbₓS₄, where x satisfies 0≤x≤0.15, Li₄₋ₓGe₁₋ₓPₓS₄, where x satisfies 0≤x≤0.15, and Li₃₊₅xP₁₋ₓS₄, where x satisfies 0≤x≤0.3.

Specific examples of the glass-based solid electrolytes include, but are not limited to, Li₂S—P₂S₅, Li₂S—P₂S₅—LiI, Li₂S—P₂S₅—P₂O₅, Li₂S—P₂S₅—LiCl, Li₂S—SiS₂, Li₂S—SiS₂—P₂S₅, Li₂S—SiS₂—Al₂S₃, Li₂S—SiS₂—LiₓMO_{y}, where Mis Si, P, or Ge.

Li₇P₃S₁₁ glass ceramics, in which a glass-based sulfide solid electrolyte is partially crystallized, can also be used. The mixing ratio of each raw material of a glass-based sulfide solid electrolyte is not limited.

The content of the solid electrolyte is not particularly limited and can be appropriately selected according to a particular application. It is preferably between 10 percent by mass and 50 percent by mass relative to the entire of the liquid composition for forming a solid electrolyte layer. The content is represented on a solid basis.

### Dispersion Medium

As for the dispersion medium, there are no particular limitations, and it can be appropriately selected according to a particular application. Examples include, but are not limited to, aqueous dispersion media such as water, ethylene glycol, and propylene glycol; amide-based dispersion media such as N-methyl-2-pyrrolidone, 2-pyrrolidone, and N,N-dimethylacetamide; ketone-based dispersion media such as cyclohexanone; ester-based dispersion media such as butyl acetate; aromatic dispersion media such as mesitylene; and alcohol-based dispersion media such as 2-n-butoxyethanol and 2-dimethylethanol.

In the case where the dispersion medium contains a positive electrode active material as the active material, amide-based, ester-based, and ketone-based dispersion media are preferred to achieve excellent dispersibility.

If the dispersion medium contains a sulfide solid electrolyte as another component, ester-based compounds are preferred. More specifically, compounds with a carbon chain of three or more carbons on the side of the carbonyl group carbon, selected from straight-chain or branched alkyl groups, and with a methyl or ethyl group on the oxygen side of the carbonyl group, are more desirable.

These can be used alone or in combination.

It is preferable for the dispersion medium to have a boiling point under atmospheric pressure.

While the boiling point of the dispersion medium is not particularly restricted and can be appropriately selected depending on the purpose, a boiling point of 100 degrees Celsius or higher is preferred for storage stability and ease of handling, with 120 degrees Celsius or higher being more preferable, and 150 degrees Celsius or higher being even more preferable. From the perspective of fast drying during the drying process, a boiling point of 300 degrees Celsius or lower is preferred, with 250 degrees Celsius or lower being more preferable, and 200 degrees Celsius or lower being even more preferable.

If a positive electrode active material is used as the active material, it is preferable for the water content in the dispersion medium to be 2,000 ppm or less, with 1,000 ppm or less being more preferable.

If the dispersion medium contains a sulfide solid electrolyte as another component, it is preferable for the water content to be 100 ppm or less, with 50 ppm or less being more preferable.

There are no particular restrictions on the method of measuring the water content in the dispersion medium, and it can be appropriately selected according to a particular application. For example, the water content can be measured using the Karl Fischer titration method based on the water evaporation method at 25 degrees Celsius. There are no particular restrictions on the measurement device either, and it can be appropriately selected according to a particular application. One specific example is a Karl Fischer moisture meter CA-200, available from Nittoseiko Analytech Co., Ltd.

The content of the dispersion medium is not particularly limited and can be appropriately selected according to a particular application. It is preferably between 40 percent by mass and 95 percent by mass relative to the entire of the liquid composition for forming the solid electrolyte layer. From the viewpoint of suppressing the formation of coffee rings during heat drying, a content of 40 percent by mass to 80 percent by mass is more preferable.

### Active Material

The active material can be either a positive electrode active material or a negative electrode active material. The positive electrode active material or negative electrode active material may be used alone or in combination of two or more.

### Positive Electrode Active Material

As a positive electrode active material, there are no particular restrictions as long as it is a material capable of reversibly intercalating and releasing alkali metal ions, and it can be appropriately selected according to a particular application. One specific example is an alkali metal-containing transition metal compound.

Specific examples of alkali metal-containing transition metal compounds include, but are not limited to, lithium-containing transition metal compounds such as composite oxides containing lithium and one or more elements selected from the group consisting of cobalt, manganese, nickel, chromium, iron, and vanadium.

Specific examples of lithium-containing transition metal compounds include lithium cobalt oxide, lithium nickel oxide, and lithium manganese oxide.

Alkali metal-containing transition metal compounds may also include polyanion compounds having an XO₄ tetrahedron (where X=P, S, As, Mo, W, Si, etc.) in their crystal structure. Of these, lithium-containing transition metal phosphate compounds such as lithium phosphate and lithium vanadium phosphate are preferable in terms of cyclability. Lithium vanadium phosphate is preferable in terms of lithium diffusion coefficient and output properties.

As for the polyanion compounds, it is preferable that the surface is coated and compounded with conductive additives such as carbon materials to enhance electronic conductivity.

It is preferable for alkali metal-containing transition metal compounds to be at least partially coated with an ion-conductive oxide on their surface. As the ion-conductive oxide, lithium ion-conductive oxides are preferable.

There are no particular limitations on the selection of lithium ion-conductive oxides, which can be selected according to a particular application.

Specific examples include, but are not limited to, oxides represented by Chemical Formula LiₓAO_{y} (where A represents B, C, Al, Si, P, S, Ti, Zr, Nb, Mo, Ta, Sc, V, Y, Ca, Sr, Ba, Hf, Ta, Cr, or W, and x and y are positive numbers).

Specific examples of lithium ion-conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, LiTaO₃, Li₂MoO₄, and Li₂WO₄. Among these, Li₄Ti₅O₁₂, Li₂ZrO₃, or LiNbO₃ is preferable. Lithium ion-conductive oxides may also be composite oxides. Any combination of lithium ion-conductive oxides may be used as composite oxides, such as Li₄SiO₄—Li₃BO₃ and Li₄SiO₄—Li₃PO₄.

### Negative Electrode Active Material

As for the negative electrode active material, there are no particular limitations as long as it is a material capable of reversibly absorbing and releasing alkali metal ions, and it can be appropriately selected according to a particular application.

For example, carbon materials containing graphite with a graphite-type crystalline structure can be used.

Examples of carbon materials include, but are not limited to, natural graphite, spherical or fibrous artificial graphite, hard carbon (non-graphitizable carbon), and soft carbon (easily graphitizable carbon).

In addition to carbon materials, examples of other materials include, but are not limited to, lithium titanate and titanium oxide.

High-capacity materials such as silicon, tin, silicon alloys, tin alloys, silicon oxide, silicon nitride, and tin oxide can also be suitably used as negative electrode active materials to increase the energy density of lithium-ion secondary batteries.

The mode diameter of the active material is not particularly limited and can be appropriately selected according to a particular application. A mode diameter between 0.5 μm and 20 μm is preferred, with a range between 3 μm and 10 μm being more preferable.

If the mode diameter of the active material is between 0.5 μm and 20 μm, discharge defects are less likely to occur when the liquid composition for forming the electrode composite layer is discharged using a liquid discharging device. Additionally, if the mode diameter of the active material is between 3 μm and 10 μm, electrodes with better battery performance can be obtained.

In the present specification, the mode diameter is calculated as the diameter at the local maximum of the particle size distribution of the active material within the liquid composition for forming the electrode composite layer.

The method of measuring the active material's modal diameter is not particularly limited and can be suitably selected to suit to a particular application. One way of measuring is according to the ISO 13320:2009 regulation (Particle size analysis—Laser diffraction methods).

he device for this measuring is not particularly limited and can be suitably selected to suit to a particular application. It includes a particle size analyzer utilizing laser diffraction, Mastersizer 3000, available from Malvern Panalytical Ltd.

The maximum particle diameter (Dmax) of the active material is not particularly limited and can be appropriately selected according to a particular application. A maximum particle diameter of 40 μm or less is preferred, with 30 μm or less being more preferable, and 20 μm or less being even more preferable.

If the maximum particle diameter Dmax of the active material is 40 μm or less, discharge defects are less likely to occur when the liquid composition for forming the electrode composite layer is discharged using a liquid discharging device.

The method of measuring the maximum particle diameter Dmax of the active material is not particularly limited and can be suitably selected to suit to a particular application. One way of measuring is according to the ISO 13320:2009 regulation (Particle size analysis—Laser diffraction methods).

The device for this measuring is not particularly limited and can be suitably selected to suit to a particular application. It includes a particle size analyzer utilizing laser diffraction, Mastersizer 3000, available from Malvern Panalytical Ltd.

The median diameter D50 of the active material is not particularly limited and can be appropriately selected according to a particular application. A maximum particle diameter of 15 μm or less is preferred, with 10 μm or less being more preferable, and 5 μm or less being even more preferable.

If the median diameter D50 of the active material is 15 μm or less, coating efficiency and battery performance improve.

The method of measuring the active material's median diameter D50 is not particularly limited and can be suitably selected to suit to a particular application. One way of measuring is according to the ISO 13320:2009 regulation (Particle size analysis—Laser diffraction methods).

The device for this measuring is not particularly limited and can be suitably selected to suit to a particular application. It includes a particle size analyzer utilizing laser diffraction, Mastersizer 3000, available from Malvern Panalytical Ltd.

### Binder

As long as the binder can bind the negative electrode materials to each other, the positive electrode materials to each other, the negative electrode materials to the negative electrode substrate, and the positive electrode materials to the positive electrode substrate, it is not particularly limited and can be appropriately selected according to a particular application. For inkjet discharging, it is preferable that the binder minimally increase the viscosity of the liquid composition for forming the electrode composite layer, to minimize nozzle clogging in the liquid discharging head.

As the binder, polymer compounds can be used.

Specific examples of polymer compounds include, but are not limited to, thermoplastic resins such as polyvinylidene fluoride (PVdF), acrylic resin, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile butadiene rubber (NBR), isoprene rubber, polyisobutene, polyethylene glycol (PEO), polymethyl methacrylate (PMMA), polyethyl methacrylate (PEMA), polybutyl methacrylate (PBMA), polyethylene vinyl acetate (PEVA), poly(2-(dimethylamino)ethyl methacrylate), poly(2-(diethylamino)ethyl methacrylate), poly[2-(dimethylamino)ethyl methacrylate-polybutyl methacrylate] copolymer, poly[2-(diethylamino)ethyl methacrylate-polybutyl methacrylate] copolymer, and carboxymethyl cellulose.

The content of the binder to an active material is not particularly restricted and can be appropriately set depending on the purpose. It is preferable that the content be between 0.5 percent by mass and 15 percent by mass, with a more preferable range between 1 percent by mass and 10 percent by mass, with a furthermore preferable range between 1.5 percent by mass and 5 percent by mass.

### Dispersant

As for dispersants, there are no particular restrictions as long as they can improve the dispersibility of the active material, and they can be appropriately selected according to a particular application. Examples include, but are not limited to, polymer dispersants such as carboxymethyl cellulose, polyethylene-based, polyethylene oxide-based, polypropylene oxide-based, polycarboxylic acid-based, naphthalene sulfonic acid formalin condensation-based, polyethylene glycol-based, partially alkyl esterified polycarboxylic acid-based, polyether-based, and polyalkylene polyamine-based dispersants; low-molecular-weight dispersants such as alkyl sulfonic acid-based, quaternary ammonium-based, higher alcohol alkylene oxide-based, polyhydric alcohol ester-based, and alkyl polyamine-based dispersants; and inorganic dispersants such as polyphosphate dispersants.

### Conductive Assistant

The conductive assistant is not particularly limited and can be suitably selected to suit to a particular application. Examples of the conductive assistant include, but are not limited to, carbon black produced by a method such as a furnace method, an acetylene method, and a gasification method, and carbon materials such as carbon nanofibers, carbon nanotubes, graphene, and graphite particles.

Conductive assistants other than the carbon materials include, but are not limited to, metal particles and metal fiber of aluminum. The conductive assistant may be combined with an active material in advance.

The content of the conductive assistant to an active material is not particularly restricted and can be adjusted according to a particular application. It is preferable for the content to be at most 10 percent by mass, with a more preferable range of at most 8 percent by mass.

A content of the conductive assistant to an active material of at most 10 percent by mass is suitable for enhancing the stability of the liquid composition for forming an electrode composite layer. A content of the conductive assistant to an active material of at most 8 percent by mass is suitable for further enhancing the stability of the liquid composition for forming a solid electrolyte layer.

### Other Optional Components

The other optional components are not particularly limited and can be suitably selected to suit to a particular application. They include, but are not limited to, surfactants, pH regulators, corrosion inhibitors, preservatives and fungicides, chelate reagents, corrosion inhibitors, anti-oxidants, reduction inhibitors, evaporation accelerators, chelating agents, and thickening agents.

The viscosity of the liquid composition for forming a solid electrolyte layer should be within a range that allows discharging from a liquid discharge head, specifically 4 mPa·s to 20 mPa·s. Preferably, the viscosity is 4 mPa·s to 12 mPa·s, and more preferably, it is 4 mPa·s to 8 mPa·s. If the viscosity is 4 mPa·s or more, the liquid composition for forming the solid electrolyte layer applied after coating can be prevented from flowing into the recesses of the electrode composite layer, thereby reducing uneven drying. Consequently, irregularities in film thickness and composition after drying can be minimized. If the viscosity is 20 mPa·s or less, the liquid composition for forming the solid electrolyte layer can more easily penetrate the voids of the electrode composite layer. This viscosity range helps prevent the liquid composition from flowing into the recesses of the electrode composite layer after application.

The method of measuring viscosity is not particularly limited and can be selected as appropriate for the purpose. For example, it can be measured at a rotation speed of 50 rpm at room temperature (25 degrees Celsius) using a viscometer (e.g., DV2T by Brookfield).

### Electrode Composite Layer Formation and Electrode Composite Layer Forming Device

The process of forming an electrode composite layer is to form an electrode composite layer on a substrate.

The device for forming an electrode composite layer is to form an electrode composite layer on a substrate.

There are no particular limitations on the electrode composite layer forming process or device, and they can be appropriately selected according to a particular application. For example, one can use a method where a dispersion, obtained by dispersing substances such as powdery active materials, binders, and conductive materials in a liquid, is applied onto a substrate, fixed, and dried. In this process, application methods such as inkjetting, spraying, dispensing, die coating, or dip coating can be suitably employed.

### Liquid Composition for Forming Electrode Composite Layer

The liquid composition for forming an electrode composite layer contains a solid electrolyte and a dispersion medium and may additionally include active materials, binders, dispersants, conductive additives, and other optional components. For the active material, binder, dispersant, conductive additive, and other components, the same types of components as those included in the liquid composition for forming a solid electrolyte layer can be used.

### Insulating Layer Formation and Insulating Layer Formation Device

The process of forming an insulating layer is to form an insulating layer on a substrate. The process of forming an insulating layer preferably includes a liquid composition applying process and a liquid composition curing process.

The device for forming an insulating layer is to form an insulating layer on a substrate. The device for forming an insulating layer preferably includes a liquid composition applying device and a liquid composition curing device.

The process of forming an insulating layer can be suitably carried out by the device for forming an insulating layer, the liquid composition applying process can be suitably carried out by the liquid composition applying device, and the liquid composition curing process can be suitably carried out by the liquid composition curing device.

### Process of Applying Liquid Composition and Device for Applying Liquid Composition

In the liquid composition application, a liquid composition is applied to a substrate.

The device for applying a liquid composition applies a liquid composition to a substrate.

The process of applying a liquid composition and the device for applying a liquid composition are not particularly limited and can be suitably selected to suit to a particular application. For example, the spin coating method, the casting method, the micro gravure coating method, the gravure coating method, the bar coating method, the roll coating method, the wire bar coating method, the dip coating method, the slit coating method, the capillary coating method, the spray coating method, the nozzle coating method, the gravure printing method, the screen printing method, the flexographic printing method, the offset printing method, the reverse printing method, and the inkjet printing method can be executed by their corresponding printing devices. Of these, inkjet printing is preferable to form an insulating layer with precision.

### Process of Curing Liquid Composition and Device for Curing Liquid Composition

The process of curing a liquid composition involves applying heat or light to the liquid composition to cure it.

The device for curing a liquid composition applies heat or light to the liquid composition to cure it.

By applying heat or light to the liquid composition, the polymerizable compound within the liquid composition undergo polymerization and polymerization-inducing phase separation, resulting in an insulating layer with a porous structure.

The light used in the process of curing a liquid composition and the device for curing a liquid composition is preferably an actinic ray.

This ray may include any type of actinic radiation that can provide the energy necessary to promote the polymerization reaction of the polymerizable compounds in the liquid composition and is not particularly limited. Examples include, but are not limited to, ultraviolet (UV) rays, electron beams, alpha rays, beta rays, gamma rays, and X-rays. Among these, ultraviolet rays are preferred. Note that in the case of using a particularly high-energy light source, polymerization reactions can be facilitated even without the use of a polymerization initiator.

There are no particular restrictions on the irradiation intensity of the actinic rays, and it can be appropriately selected according to the intended purpose. It is preferably at most 1 W/cm², more preferably at most 300 mW/cm², and even more preferably at most 100 mW/cm².

An excessively low irradiation intensity of the actinic rays can lead to excessive progression of polymerization-induced phase separation, causing variations and coarsening of the porous structure, and longer irradiation times may reduce productivity. Therefore, it is preferably at least 10 mW/cm², and more preferably at least 30 mW/cm².

### Other Processes and Other Devices

The other optional process relating to the method of manufacturing an electrode for electrochemical elements is not particularly limited and it can be suitably selected to suit to a particular application unless it has an adverse impact on the effects of the present disclosure. It includes, for example, a process of solvent removing.

The other optional devices relating to the device for manufacturing an electrode for electrochemical elements is not particularly limited and it can be suitably selected to suit to a particular application unless it has an adverse impact on the effects of the present disclosure. It includes, for example, a process of solvent removing.

### Solvent Removing Process and Solvent Removing Device

The solvent removing process is to remove the solvent from the insulating layer.

The solvent removing device is to remove the solvent from the insulating layer.

No particular specific restrictions apply to the solvent removal process or the device used for it, and they may be selected as appropriate based on the purpose. One method of removing solvent from the insulating layer is heating. In this case, it is preferable to heat under reduced pressure, as this pressure promotes solvent removal and reduces the amount of residual solvent in the insulating layer.

Heating can be done using a stage, or a heating mechanism other than a stage may be used. The heating mechanism may be installed on either the upper or lower side of the substrate, or multiple heating mechanisms may be installed. There are no particular restrictions on the heating mechanism; examples include, but are not limited to, resistance heaters, infrared heaters, and fan heaters. There is no particular limit to the heating temperature, but in terms of energy use, it is preferably between 70 degrees Celsius and 150 degrees Celsius.

In the method of manufacturing electrodes for electrochemical devices, there are no particular restrictions on the order of the insulating layer forming process and the electrode composite layer forming process. Specifically, the electrode composite layer forming process may be performed before the insulating layer forming process, with the insulating layer being formed around the outer periphery of the electrode composite layer after its formation. In this case, the method of manufacturing electrodes for electrochemical devices involves performing the electrode composite layer forming process, the insulating layer forming process, and then the solvent removal process in that order.

Similarly, the electrode composite layer forming process may be performed after the insulating layer forming process, with the insulating layer being formed around the outer periphery of the substrate, and then the electrode composite layer being formed inside the insulating layer. In this case, the method of manufacturing electrodes for electrochemical devices involves performing the insulating layer forming process, the electrode composite layer formation process, and then the solvent removal process in that order.

### Electrode for Electrochemical Element

The laminate for a solid state electrochemical element according to the present disclosure can be suitably applied to electrodes for electrochemical elements.

The electrode for electrochemical elements includes a substrate, an electrode composite layer containing an active material formed on the substrate, and a solid electrolyte layer on the electrode composite layer. The electrode composite layer includes a solid electrode layer and an electrode layer and has protrusions (convex portions) of 5 μm or more, and the ratio (A/B) of the film thickness of the protrusions (A) to the film thickness of the recesses (concave portions) (B) in the solid electrolyte is 0.8 to 1.2.

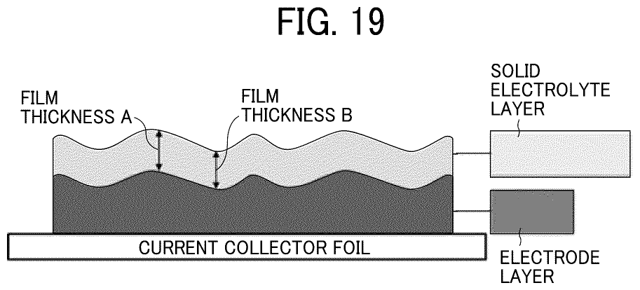

FIG. 19 is a schematic diagram illustrating an image of the convex and concave portions of the solid electrode layer to show the film thickness A of the protrusion portions and the film thickness B of the recess portions of the solid electrode layer of the electrode composite layer.

Note that the substrate, solid electrolyte, and insulating layer are identical to those described in the aforementioned sections, and redundant descriptions are omitted.

In the present specification, the negative electrode and the positive electrode may be referred to as “electrodes,” and the negative electrode substrate and the positive electrode substrate may be referred to as “substrates.” The negative electrode composite layer and the positive electrode composite layer may also be referred to as “electrode composite layers.” In addition, if the first electrode is a negative electrode, the second electrode refers to the positive electrode, and if the first electrode is a positive electrode, the second electrode refers to the negative electrode.

Embodiment of the present disclosure are described with reference to the drawings. The present disclosure is not limited to these embodiments.

In the drawings, identical components may be denoted by the same reference numerals (or symbols), and redundant descriptions may be omitted. Additionally, the present disclosure is not restricted to the specific numbers, positions, or shapes of the configurations described below. These parameters may be appropriately selected to suit the implementation of the present disclosure.

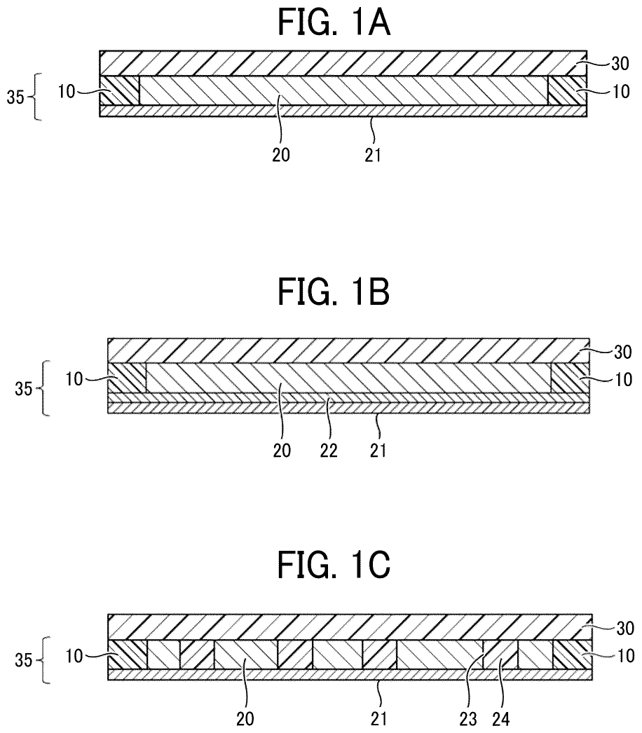

FIG. 1A is a schematic diagram illustrating a cross sectional view of an electrode laminate according to a different embodiment of the present disclosure. FIG. 1B is a schematic diagram illustrating a cross sectional view of an electrode laminate according to another embodiment of the present disclosure. FIG. 1C is a schematic diagram illustrating a cross sectional view of an electrode laminate according to yet another embodiment of the present disclosure. The electrode laminate 35 includes a first substrate 21, a first electrode composite layer 20 disposed on the first substrate 21, an insulating layer 10 disposed on the outer periphery of the electrode composite layer 20, and a solid electrolyte layer 30 disposed on the electrode composite layer 20 and the insulating layer 10.

Note that FIGS. 1A to 1C illustrate the configuration in which the electrode composite layer 20, the insulating layer 10, and the solid electrolyte layer 30 are provided on one side of the first substrate 21, but the electrode composite layer 20, the insulating layer 10, and the solid electrolyte layer 30 may be provided on both opposing sides of the first substrate 21.

Furthermore, as illustrated in FIG. 1B, an adhesive layer 22 containing a metal that forms an alloy with lithium may be provided between the first substrate 21 and the electrode composite layer 20.

### Solid Electrolyte Layer

There are no particular limitations on the solid electrolyte layer (hereinafter sometimes referred to as an active material layer), and it can be appropriately selected according to a particular application. For example, it may contain an active material (negative electrode active material or positive electrode active material) and a sulfide solid electrolyte, and, if necessary, it may further contain conductive additives, binders, dispersants, and other components.

The components contained in the solid electrolyte layer are identical to those described in the Liquid Composition for Forming Solid Electrolyte Layer section, and therefore, redundant descriptions are omitted.

The average thickness of the substantially solid electrolyte layer has no particular limit and can be suitably selected to suit to a particular application. It is preferably from 2 to 40 μm.

The ratio (A/B) of the film thickness of the protrusions—convex portions—(A) to the film thickness of the recesses—concave portions—(B) in the solid electrolyte is preferably between 0.8 and 1.2. This configuration enables the production of an electrode for electrochemical elements with excellent battery performance.

### Electrode Composite Layer

There are no particular limitations on the electrode composite layer (hereinafter sometimes referred to as an active material layer) as long as it has a rough structure, and it can be appropriately selected according to a particular application. For example, it may contain an active material (negative electrode active material or positive electrode active material) and a sulfide solid electrolyte, and, if necessary, it may further contain conductive assistants, binders, dispersants, and other components.

The electrode composite layer preferably contains an active material and a sulfide solid electrolyte, so that the electrode for the electrochemical element or the electrode laminate has an insulating layer that minimizes degradation in ionic conductivity in the sulfide solid electrolyte-containing layer.

The height difference in the surface of the electrode composite layer is not particularly limited and can be appropriately selected according to a particular application. It is preferably 5 μm or more.

This surface roughness increases the surface area between the electrode composite layer and the solid electrolyte layer, improving battery performance.

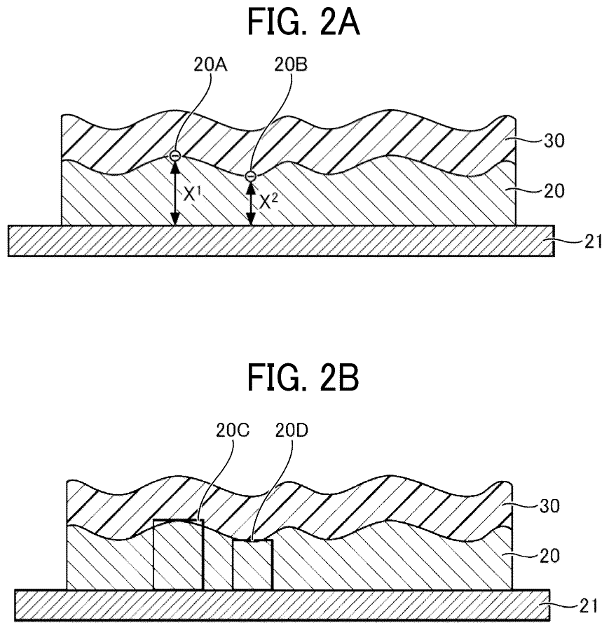

The height difference of the surface refers to the difference between the height X1, measured from the surface of the substrate 21 to a protrusion 20A of the electrode composite layer 20, and the height X2, measured from the surface of the substrate 21 to a recess 20B of the electrode composite layer 20, as illustrated in FIG. 2A.

The surface roughness—height difference—can be measured using, for example, a laser microscope based on the surface profile.

In this embodiment, the protrusions and recesses of the electrode composite layer are preferably formed in a substantially periodic and alternating manner. In the present specification, the protrusions and recesses of the rough structure do not include those formed solely by a single active material particle contained in the electrode composite layer on the surface of the active material layer.

The porosity difference in the electrode composite layer is not particularly limited and can be appropriately selected according to a particular application. It is preferably between 0 percent and 10 percent. This porosity difference ensures that the rate at which the liquid composition for forming a solid electrolyte layer permeates the electrode composite layer is uniform, enabling the formation of a solid electrolyte layer with uniform thickness.

The porosity difference refers to the difference between the porosity of a region 20C in the protrusion of the electrode composite layer 20, with a radius of 50 μm and a thickness of 2 μm to 40 μm, and the porosity of a region 20D in the recess of the electrode composite layer 20, with a radius of 50 μm and a thickness of 2 μm to 40 μm, as shown in FIG. 2B.

The electrode composite layer may have an opening 23 as illustrated in FIG. 1C.

The number of openings 23 is preferably one or more, and more preferably multiple.

The openings 23 may penetrate the electrode composite layer from the surface of the electrode composite layer to the surface of the substrate, or it may not penetrate to the surface of the substrate.

The openings 23 may be hollow or filled with a material 24. If the openings 23 are filled with the material 24, the material 24 may be a single substance or a mixture of two or more substances, but in either case, the material 24 should be different in nature (compound or composition) from the material constituting the electrode composite layer. The material 24 preferably contains the solid electrolyte of the sulfide solid electrolyte-containing layer to improve ion conductivity, and more preferably is a material with the same composition as that of the sulfide solid electrolyte the sulfide solid electrolyte-containing layer contains.

An electrode composite layer with the openings 23 can be suitably manufactured using inkjet as an electrode composite layer forming device because coating control is easy.

### Insulating Layer

The insulating layer in the electrode and electrode laminate for the electrochemical element related to the present disclosure is arranged on the outer periphery of the electrode composite layer disposed on the substrate, and may also be arranged on the substrate and on the outer periphery of the substrate.

Embodiment of the present disclosure are described with reference to the drawings. The present disclosure is not limited to these embodiments.

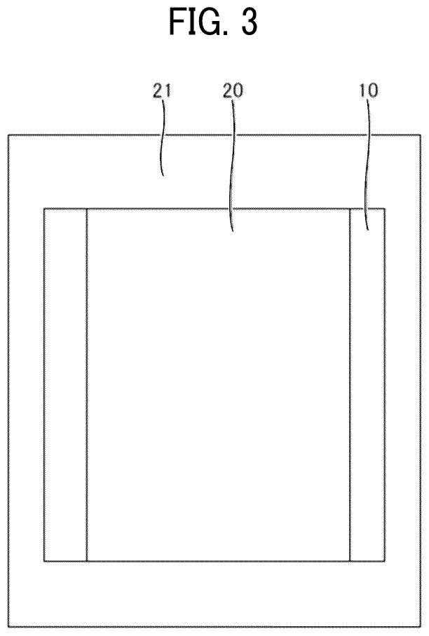

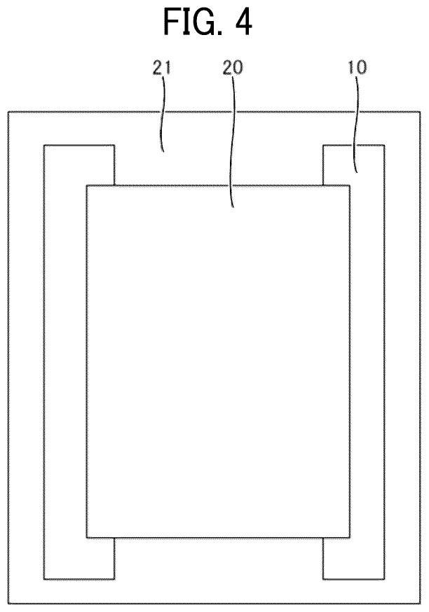

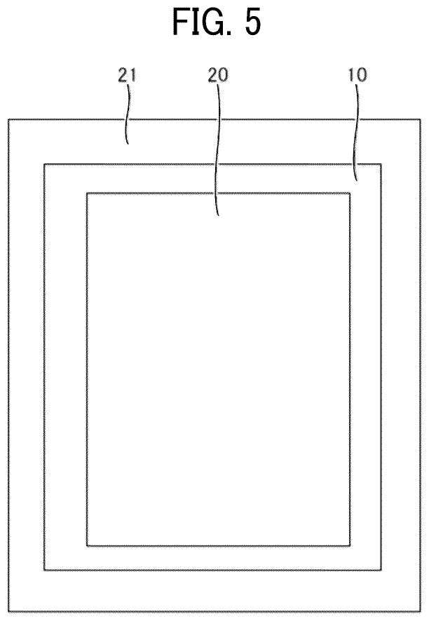

FIG. 3 is a schematic diagram illustrating a top view of an electrode for an electrochemical element according to one embodiment of the present disclosure. FIG. 4 is a schematic diagram illustrating a top view of an electrode for another electrochemical element according to one embodiment of the present disclosure. FIG. 5 is a schematic diagram illustrating a top view of an electrode for yet another electrochemical element according to one embodiment of the present disclosure.

In FIG. 3, the insulating layer 10 is provided in contact with two sides of the outer periphery of the electrode composite layer 20.

In FIG. 4, the insulating layer 10 is provided in contact with the two long sides of the outer periphery of the electrode composite layer 20, as well as to the two corners of those long sides.

In FIG. 5, the insulating layer 10 is provided continuously in contact with all four sides of the outer periphery of the electrode composite layer 20. The insulating layer may also be provided in contact with the sides in a discontinuous manner.

In the present specification, “arranged on the outer periphery of the electrode composite layer” means that the insulating layer may be arranged on at least two sides of the outer periphery of the electrode composite layer, on three sides of the outer periphery of the electrode composite layer, or on all four sides of the outer periphery of the electrode composite layer. Additionally, the insulating layer may have recesses or notches on any side for the protrusion of electrode tabs.

In the present specification, the phrase “arranged on the outer periphery of the substrate” means that the insulating layer may be arranged so as to cover the edge of the substrate, or it may be arranged in such a way that the substrate is exposed, as illustrated in FIGS. 3 to 5.

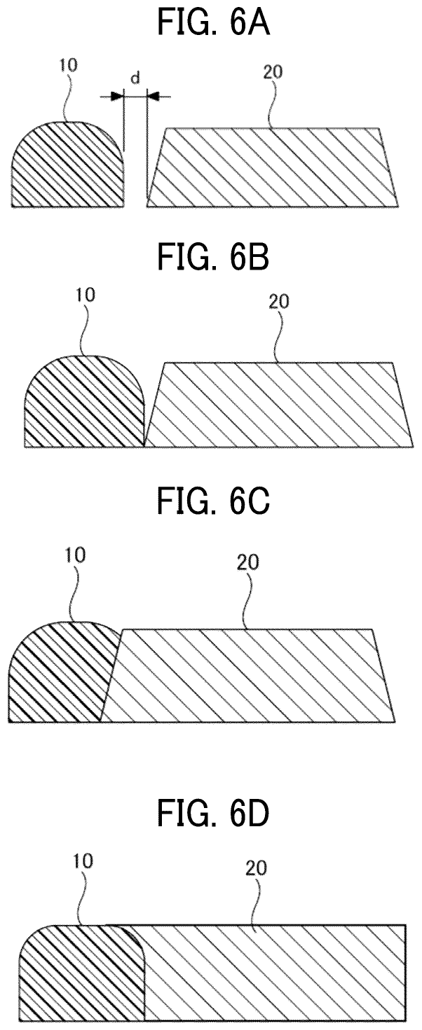

FIG. 6A is a schematic diagram illustrating a cross sectional view (part 1) of a positional relationship between the insulating layer and electrode composite layer in an electrode for electrochemical element according to the present disclosure. FIG. 6B is a schematic diagram illustrating a cross sectional view (part 2) of a positional relationship between the insulating layer and electrode composite layer in an electrode for electrochemical element according to the present disclosure. FIG. 6C is a schematic diagram illustrating a cross sectional view (part 3) of a positional relationship between the insulating layer and electrode composite layer in an electrode for electrochemical element according to the present disclosure. FIG. 6D is a schematic diagram illustrating a cross sectional view (part 4) of a positional relationship between the insulating layer and electrode composite layer in an electrode for electrochemical element according to the present disclosure.

The insulating layer 10 may be spaced apart from the electrode composite layer 20, as illustrated in FIG. 6A, or it may be in contact with the electrode composite layer 20, as illustrated in FIGS. 6B to 6D. Among these configurations, it is preferable for the insulating layer 10 to be in contact with the electrode composite layer 20.

In the case in which the insulating layer 10 is in contact with the electrode composite layer 20, the facing surfaces of the insulating layer 10 and the electrode composite layer 20 may be partially in contact, as illustrated in FIG. 6B, or they may be in full contact, as illustrated in FIGS. 6C to 6D.

If the electrode composite layer 20 is provided after the formation of the insulating layer 10, the electrode composite layer 20 overlaps with the insulating layer 10, as illustrated in FIG. 6C. Similarly, if the insulating layer 10 is provided after the formation of the electrode composite layer 20, the insulating layer 10 overlaps with the electrode composite layer 20, as illustrated in FIG. 6D.

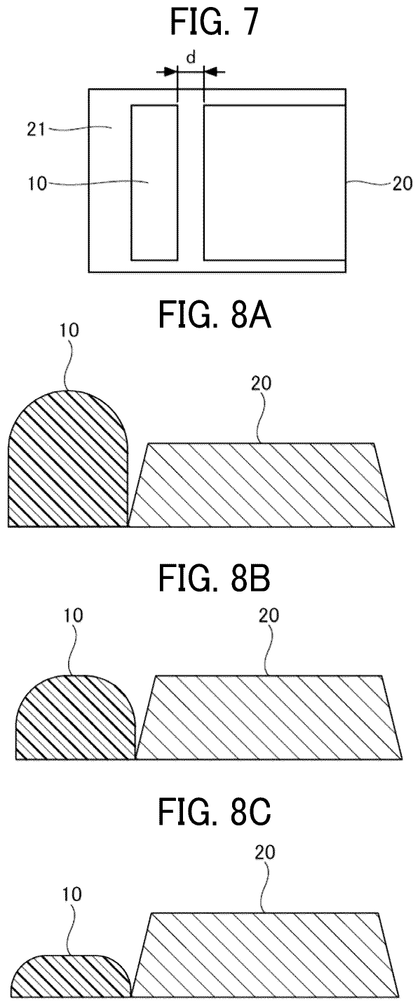

FIG. 7 is a schematic diagram illustrating a top view of a positional relationship between the insulating layer and electrode composite layer in an electrode for electrochemical element according to the present disclosure.

If the insulating layer 10 and the electrode composite layer 20 are spaced apart, a distance d between the insulating layer 10 and the electrode composite layer 20 (the distance between the outer periphery of the electrode composite layer 20 and the insulating layer) is defined as illustrated in FIG. 7. That is, if the insulating layer 10 and the electrode composite layer 20 are adjacent, the distance is d=0, and the distance d between the insulating layer and the electrode composite layer is defined as the distance between the arrows illustrated in FIG. 7. In cases where the insulating layer overlaps the electrode composite layer, as illustrated in FIGS. 6C and 6D, or where the electrode composite layer overlaps the insulating layer, a negative value is used to represent this distance.

There are no particular restrictions on the distance d between the insulating layer 10 and the electrode composite layer 20 (the distance between the outer periphery of the electrode composite layer 20 and the insulating layer), and it can be appropriately selected based on the purpose. It is preferable for the distance to be at most 10 mm, more preferably at most 5 mm, and even more preferably at most 1 mm.

A distance d between the insulating layer 10 and the electrode composite layer 20 of at most 10 mm makes it easier for the insulating layer and the electrode composite layer to come into contact after a pressing process, suitably leading to the formation of a uniform solid electrolyte layer on the insulating layer and the electrode composite layer. Moreover, when the solid electrolyte layer is pressed, it is preferable because uniform pressure can be applied to the solid electrolyte layer.

FIG. 8A is a schematic diagram illustrating a cross sectional view (part 1) of a relationship of the average thickness between the insulating layer and electrode composite layer in an electrode for electrochemical element according to the present disclosure. FIG. 8B is a schematic diagram illustrating a cross sectional view (part 2) of a relationship of the average thickness between the insulating layer and electrode composite layer in an electrode for electrochemical element according to the present disclosure. FIG. 8C is a schematic diagram illustrating a cross sectional view (part 3) of a relationship of the average thickness between the insulating layer and electrode composite layer in an electrode for electrochemical element according to the present disclosure.

There are no particular restrictions on the relationship between the average thickness A of the electrode composite layer and the average thickness B of the insulating layer in the electrode laminate relating to the present disclosure, and the thicknesses can be appropriately selected depending on the purpose. For example, as illustrated in FIGS. 8A to 8C, A<B, A=B, or A>B may all be acceptable. Among these, A=B or A<B is preferable.

The average thickness of the insulating layer is not particularly limited and can be appropriately selected according to the conditions such as the average thickness of the electrode composite layer. An average thickness of the insulating layer between 1.0 μm and 150.0 μm is preferred, with a range between 10.0 μm and 100.0 μm being more preferable.

An average thickness of the insulating layer of at least 10.0 μm can suitably distribute the pressure load during pressing and prevent short circuits between the positive and negative electrodes.

If the average thickness of the insulating layer is at most 100.0 μm, it is possible to manufacture an electrochemical element with high density and excellent battery characteristics.

There are no particular restrictions on the ratio (B/A) of the average thickness B of the insulating layer to the average thickness A of the electrode composite layer in the electrode laminate of the present disclosure, and it can be appropriately selected depending on the purpose. It is preferably 0.97 to 1.03, and more preferably 0.98 to 1.02.

There are no particular restrictions on the method of measuring the average thickness A of the electrode composite layer and the average thickness B of the insulating layer, and it can be appropriately selected depending on the purpose. For example, the thickness at three or more arbitrary points can be measured, and the average value can be calculated.

Since the insulating layer in the electrode laminate relating to the present disclosure has a porous structure, the thickness of the electrode composite layer and the insulating layer can be easily and precisely controlled through pressing.

Moreover, since the insulating layer can be formed by coating and polymerization-induced phase separation methods, the thickness can be easily controlled. If the insulating layer has a co-continuous structure, it can efficiently disperse the pressure generated during pressing, preventing issues such as damage to the insulating layer or unevenness regarding height, thus ensuring the production of a high-quality insulating layer.

There are no particular restrictions on the compression ratio of the insulating layer (after pressing at 500 MPa for 5 minutes), and it can be appropriately selected depending on the purpose. It is preferably between 1 percent and 50 percent, and more preferably between 5 percent and 20 percent.

A compression ratio of at most 50 percent enhances the strength of the insulating layer, ensuring adequate shape retention after the pressing process.

A compression ratio of the insulating layer at least 1 percent alleviates the pressure on the sulfate solid electrolyte layer from the insulating layer during the pressing process after the sulfate solid electrolyte layer is formed.

The insulating layer may include at least one of a resin and an inorganic oxide. In terms of increasing the energy density per unit weight of the battery and reducing weight, an insulating resin layer containing a resin is preferred, and a porous insulating resin layer is even more preferred.

### Substrate

The substrate is not particularly limited as long as it has electronic conductivity and is stable with respect to the applied potential. It can be appropriately selected according to a particular application. Examples include, but are not limited to, aluminum foil, copper foil, stainless steel foil, titanium foil, etched foil with fine holes created by etching such foil, carbon-coated foil with a surface layer coated with a carbon-containing resin layer, foil coated with a PTC (phase-transfer catalyst) layer, and perforated substrates used in lithium-ion capacitors.

In the present specification, the substrate used for the negative electrode may be referred to as a “negative electrode substrate” or a “substrate for a negative electrode,” while the substrate used for the positive electrode may be referred to as a “positive electrode substrate” or a “substrate for a positive electrode.”

### Electrode Laminate

The electrode for an electrochemical element of the present disclosure can be suitably applied to an electrode laminate.

The electrode laminate preferably includes an electrode for an electrochemical element and a sulfide solid electrolyte-containing layer disposed on the electrode for an electrochemical element. In other words, the electrode laminate preferably includes a substrate, an electrode composite layer containing a sulfide solid electrolyte disposed on the substrate, an insulating layer disposed on the outer peripheral portion of the electrode composite layer, and a sulfide solid electrolyte-containing layer disposed on the electrode composite layer and the insulating layer.

The substrate, sulfide solid electrolyte, sulfide solid electrolyte-containing layer, and insulating layer are the same as those described items, and repeated descriptions are omitted.

### Method of Manufacturing Electrode Laminate and Device for Manufacturing Electrode Laminate

The method of manufacturing electrode laminate according to the present disclosure includes the insulating layer forming process, the electrode composite layer forming process, and the solid electrolyte layer forming process. Additionally, it may optionally include a pressing process and other processes.

The device for manufacturing electrode laminate according to the present disclosure preferably includes a accommodating unit, an insulating layer forming device, an electrode composite layer forming device, and a solid electrolyte layer forming device. It may optionally also include pressing device and other devices.

Note that the storage container, the insulating layer forming process, the insulating layer forming device, the electrode composite layer forming device, the electrode composite layer forming device, other processes, and other devices are similar to those described in the sections on the method of manufacturing electrodes for electrochemical devices and the device for manufacturing electrodes for electrochemical devices. Therefore, redundant descriptions are omitted.

### Pressing Process and Pressing Device

The pressing process is to press the electrode composite layer and insulating layer.

The pressing device is to press the electrode composite layer and insulating layer.

The pressing process is suitably executed by the pressing device.

Regarding the pressing process and device, there are no particular restrictions; it can be performed using commercially available pressure molding equipment. The electrode composite layer and the insulating layer are possibly pressed in the substrate direction. Examples include, but are not limited to, uniaxial presses, roll presses, cold isostatic presses (CIP), and hot presses. Among these, cold isostatic presses (CIP), which can apply isotropic pressure, are preferred.

There are no particular restrictions on the timing of the pressing process; it can be appropriately selected according to the objective. For example, the electrode composite layer and the insulating layer can be pressed after being formed on the substrate, or the pressing can be done after the solid electrolyte layer has been provided, or at both timings.

Carrying out the pressing process after forming the electrode composite layer and the insulating layer on the substrate, but before forming the solid electrolyte layer, makes the average thickness of the electrode composite layer and the average thickness of the insulating layer approximately equal. This sequence helps to distribute the pressure load, even if high pressure is applied during pressing the solid electrolyte layer provided on the electrode.

Regarding the pressing pressure, there are no particular restrictions, and it can be appropriately selected according to the objective; however, it is preferable to apply a pressure that enables the substrate and the electrode composite layer to be bonded and densification of the electrode composite layer at the same time. More specifically, a pressure between 1 MPa and 900 MPa is preferable, and a range between 250 MPa and 700 MPa is even more preferable.

### Embodiment for Forming insulating layer or Electrode Laminate by Directly Applying Liquid Composition to Substrate

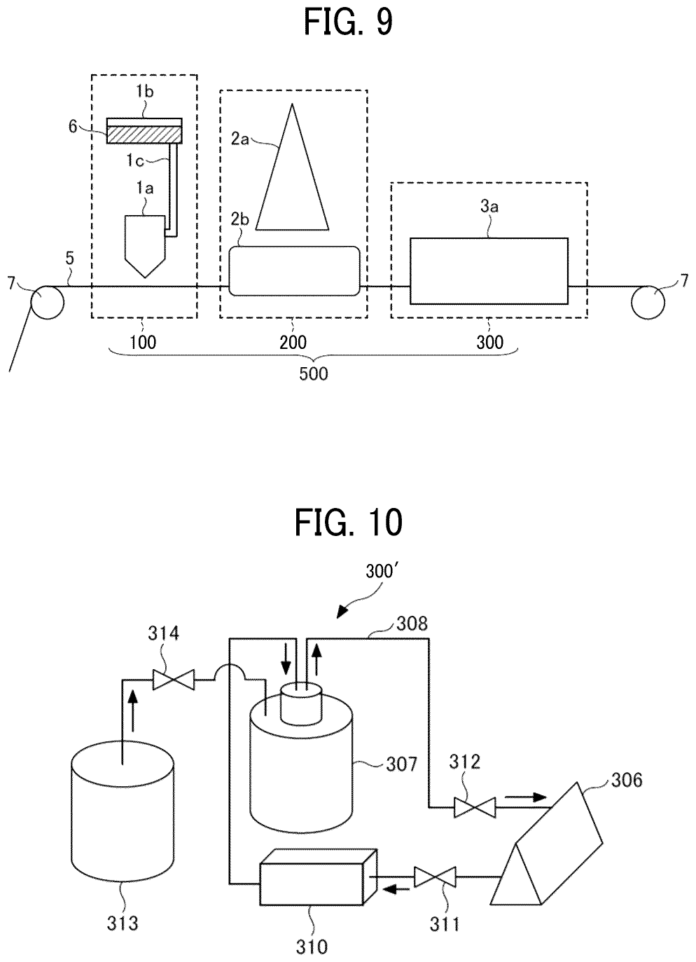

FIG. 9 is a schematic diagram illustrating an example of a device (liquid discharging device) for manufacturing an insulating layer to execute the method of manufacturing the electrode laminate relating to the present disclosure.

An insulating layer manufacturing device 500 includes a conveyance unit 5, a printing unit 100, a polymerization unit 200, a heating unit 300, and a roller 7.

The conveyance unit 5 conveys a printing substrate at a preset speed in the order of the printing unit 100, the polymerization unit 200, and the heating unit 300.

The printing substrate may have an electrode composite layer thereon, or it may be without an electrode composite layer. If the substrate does not have an electrode composite layer, the electrode composite layer is provided after the formation of the insulating layer.

### Printing Unit 100

The printing unit 100 includes a printing device 1a, which is an example of a liquid composition applying device for carrying out liquid composition application on the printing substrate, a storage container 1b that contains the liquid composition 6, and a supply tube 1c that supplies the liquid composition stored in the storage container 1b to the printing device 1a.

The printing unit 100 discharges the liquid composition 6 from the printing device 1a onto the printing substrate, forming the liquid composition into a thin film. The storage container 1b may be configured to be integrated with or detachable from the insulating layer manufacturing device. Additionally, the storage container 1b may be designed to add materials to a container that is either integrated with or detachable from the insulating layer manufacturing device.

There are no particular limitations on the storage container 1b and supply tube 1c as long as they can stably store and supply the liquid composition 6, and they can be appropriately selected according to a particular application.

It is preferable that the materials constituting the storage container 1b and supply tube 1c have light-shielding properties in the relatively short wavelength regions of ultraviolet and visible light. Such materials are preferred to prevent the liquid composition 6 from initiating polymerization due to exposure to external light.

### Polymerization Unit 200

As illustrated in FIG. 9, in the case of photopolymerization, the polymerization unit 200 includes a light irradiation device 2a, which is an example of a liquid composition curing device for carrying out the liquid composition curing process, and a polymerization inert gas circulation device 2b, which circulates an inert gas for polymerization.

The light irradiation device 2a irradiates the thin film-like liquid composition formed by the printing unit 100 with light in the presence of a polymerization inert gas, initiating photopolymerization to obtain an insulating layer precursor.

The light irradiation device 2a is not particularly limited as long as it can initiate and progress the polymerization of compounds in the liquid composition. It can be selected appropriately according to the absorption wavelength of the photopolymerization initiator contained in the liquid composition. Examples include, but are not limited to, ultraviolet light sources such as high-pressure mercury lamps, metal halide lamps, thermal positive electrode tubes, cold positive electrode tubes, and LEDs. However, since light with shorter wavelengths tends to penetrate more deeply, it is preferable to select the light source according to the thickness of the insulating layer to be formed.

The polymerization inert gas circulation device 2b reduces the concentration of polymerization-active oxygen in the atmosphere to prevent the inhibition of polymerization reactions of polymerizable compounds near the surface of the liquid composition. Inert gases for polymerization include, for example, nitrogen, carbon dioxide, and argon.

It is preferable to maintain the O₂ concentration in the inert gas below 20 percent (a lower oxygen concentration than in the atmosphere) to achieve a greater inhibition reduction effect. More preferably, the O₂ concentration should be between 0 and 15 percent, and even more preferably between 0 and 5 percent.

Additionally, it is preferable for the polymerization inert gas circulation device 2b to be equipped with a temperature control device to ensure stable polymerization conditions.

The polymerization unit 200 may be a heating device in the case of thermal polymerization. There are no particular limitations on the heating device, and it can be appropriately selected according to a particular application. Examples include, but are not limited to, substrate heating (such as hot plates), IR heaters, and hot air heaters, which may also be used in combination.

Additionally, the heating temperature and time, or the conditions for light irradiation, can be appropriately selected according to the polymerizable compounds contained in the liquid composition and the thickness of the formed film.

There are no particular limitations on the polymerization unit 200, and it can be appropriately selected according to a particular application, such as the polymerization initiator or polymerization method to be used.

For example, a light irradiation device that emits ultraviolet light with a wavelength of 365 nm for 3 seconds can be used in the case of photopolymerization, and a heating device that heats at 150 degrees C. under vacuum for 12 hours can be used in the case of thermal polymerization.

### Heating Unit 300

The heating unit 300 includes a heating device 3a, which is an example of a solvent removal device for carrying out the solvent removal process.

As illustrated in FIG. 9, the heating device 3a heats the insulating layer precursor formed by the polymerization unit 200 to dry and remove any remaining solvent. At this time, the solvent removal process may be conducted under reduced pressure.

The heating unit 300 executes a polymerization promotion process of heating the insulating layer precursor with the heating device 3a to further accelerate the curing (polymerization) reaction performed in the polymerization unit 200.

Additionally, it carries out an initiator removal process of heating and drying them with the heating device 3a to remove any remaining photopolymerization initiators in the insulating layer precursor. These polymerization promotion and initiator removal processes do not need to be conducted simultaneously with the solvent removal process; they may be performed before or after the solvent removal process.

The heating unit 300 also carries out a polymerization completion process, where the insulating layer is heated under reduced pressure after the solvent removal process.

The heating temperature and time can be appropriately selected according to the boiling point of the solvent contained in the insulating layer precursor and the thickness of the formed film.

FIG. 10 is a schematic diagram illustrating another example of a device (liquid discharging device) for manufacturing an insulating layer to execute the method of manufacturing an electrode laminate according to one embodiment of the present disclosure.

A liquid discharging device 300′ allows the liquid composition to circulate through a liquid discharging head 306, a liquid discharging head tank 307, and a tube 308 by adjusting a pump 310 and valves 311 and 312.

The liquid discharging device 300′ is equipped with an external tank 313, allowing the liquid composition to be supplied from the external tank 313 to the liquid discharging head tank 307 by adjusting the pump 310 and operating the valves 311, 312, and 314 when the liquid composition in the head tank 307 decreases.

The device for manufacturing the insulating layer allows the liquid composition to be discharged precisely onto the targeted areas of an object.

The insulating layer manufacturing device 500 may be equipped with a mechanism to cap the nozzle to prevent drying when the liquid composition 6 is not being discharged from the liquid discharging head.

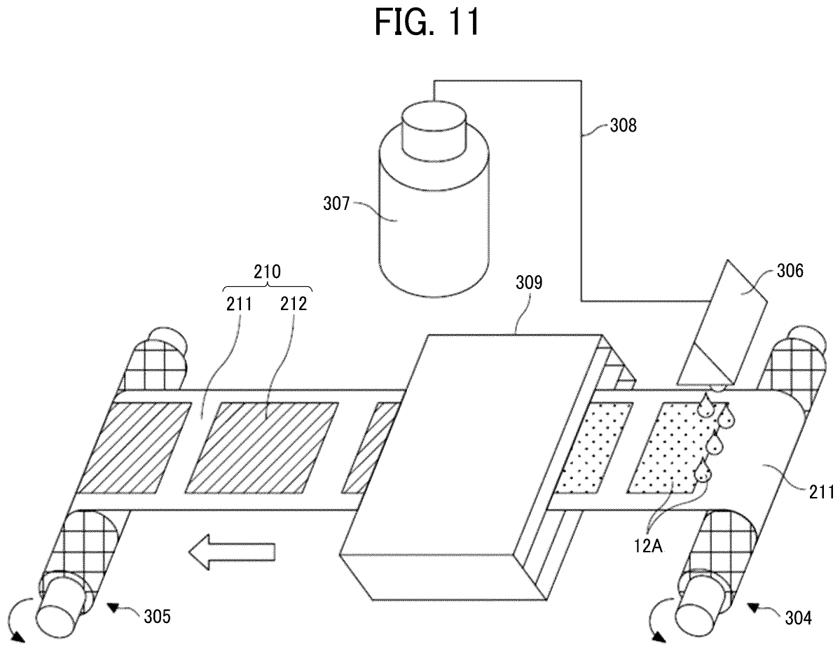

FIG. 11 is a schematic diagram (part 1) illustrating a method of manufacturing an electrode for an electrochemical element according to one embodiment of the present disclosure.

The method of manufacturing an electrode 210 for an electrochemical element, which has an insulating layer formed on a substrate, includes a process of sequentially discharging a liquid composition 12A onto a substrate 211 using the liquid discharging device 300′.

First, a slender substrate is prepared as the substrate 211. The substrate 211 is then wound around a cylindrical core, with the side where the insulating layer 212 is to be formed facing upwards as illustrated in FIG. 11, and is placed between a feed roller 304 and a take-up roller 305. The feed roller 304 and the take-up roller 305 rotate counterclockwise to convey the substrate 211 from right to left in FIG. 11. Then in the same manner as in FIG. 10, the liquid discharging head 306 positioned above the substrate 211 sequentially discharges droplets of the liquid composition 12A onto the substrate 211, which is conveyed between the feed roller 304 and the take-up roller 305.

Note that two or more of the liquid discharging heads 306 can be positioned in the direction substantially parallel or perpendicular to the conveyance direction of the substrate 211.

Next, the substrate 211, onto which the droplets of liquid composition 12A have been discharged, is conveyed to the polymerization unit 309 by the feed roller 304 and the take-up roller 305. As a result, the liquid composition 12A is polymerized to form the insulating layer 212, resulting in an electrode 210 for the electrochemical element with an insulating layer on the substrate. Subsequently, the electrode 210 for the electrochemical element is cut to a desired size through processes such as punching.

The polymerization unit 309 may be installed on either the upper or lower side of the substrate 211, or multiple units may be disposed.

The polymerization unit 309 is not particularly limited as long as it does not directly contact the liquid composition 12A, and can be appropriately selected according to the intended purpose. For example, in the case of thermal polymerization, options include resistance heating heaters, infrared heaters, and fan heaters, while in the case of photopolymerization, ultraviolet irradiation devices can be used. Two or more of the polymerization unit 309 can be disposed.

There is no specific limitation to the conditions for heating or light irradiation. It can be selected to suit to a particular application.

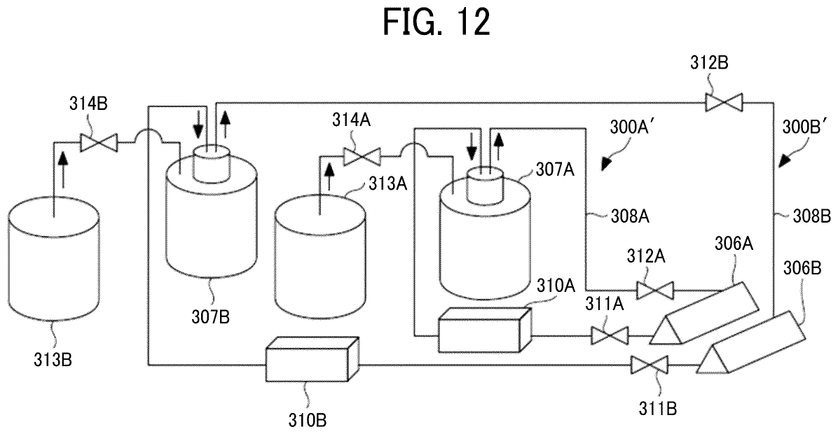

FIG. 12 is a schematic diagram illustrating another example of a device (liquid discharging device) for manufacturing an insulating layer to execute the method of manufacturing an electrode laminate according to one embodiment of the present disclosure.

The liquid discharging devices 300A′ and a 300B′ may be used in combination.

Specifically, the liquid composition may be supplied from external tanks 313A and 313B connected to liquid discharging head tanks 307A and 307B, respectively, and the liquid discharging heads may include multiple heads 306A and 306B. Additionally, the system may include tubes 308A and 308B, valves 311A, 311B, 312A, 312B, and 314A, as well as pumps 310A and 310B.

### Embodiment for Forming insulating layer or Electrode Laminate by Indirectly Applying Liquid Composition to Substrate

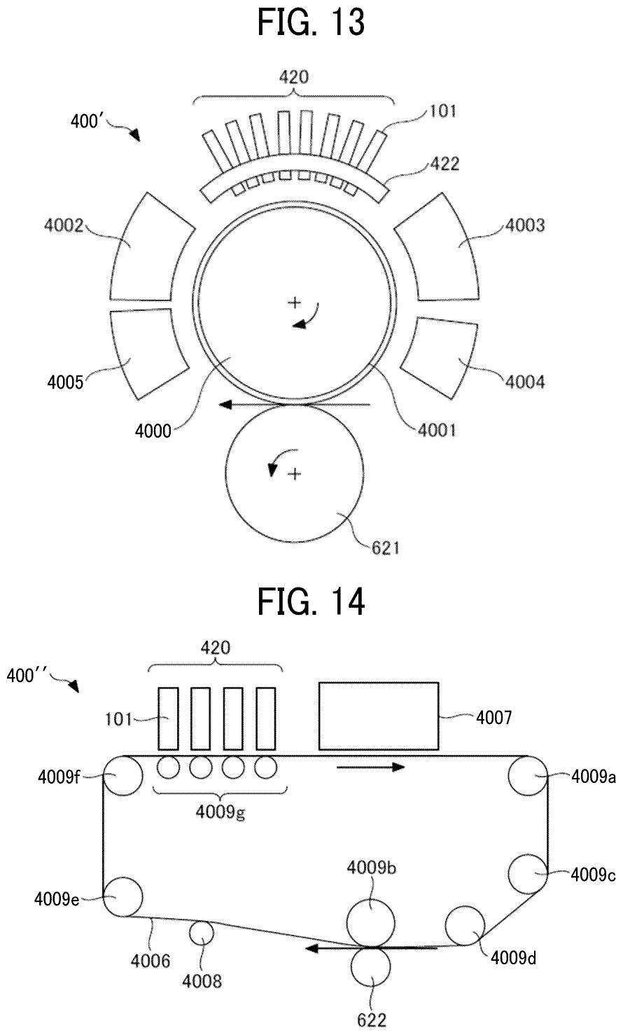

FIG. 13 is a configuration diagram (part 1) illustrating another example of a printing unit in which an inkjet method and a transfer method are adopted as the liquid composition application device in an insulating layer manufacturing device according to the present disclosure. In the printing unit illustrated in FIG. 13, a drum-shaped intermediate transfer body is used.

A printing unit 400′ is an inkjet printer that forms an insulating layer on a substrate by transferring the liquid composition or the insulating layer onto the substrate via an intermediate transfer member 4001.

The printing unit 400′ includes an inkjet unit 420, a transfer drum 4000, a pretreatment unit 4002, an absorption unit 4003, a heating unit 4004, and a cleaning unit 4005.

The inkjet unit 420 includes a head module 422 carrying multiple heads 101.

The heads 101 discharge a liquid composition to the intermediate transfer member 4001 supported by the transfer drum 4000 to form a liquid composition layer on the intermediate transfer member 4001. Each of the heads 101 is a line head. The nozzles thereof are disposed to cover the width of the printing region of the maximally usable substrate. The heads 101 have a nozzle surface formed with nozzles on its lower side, and the nozzle surface faces the surface of the intermediate transfer member 4001 through a minute gap. In the present embodiment, the intermediate transfer member 4001 is configured to move circularly on a circular orbit. The heads 101 are thus radially positioned.

The transfer drum 4000 faces an impression cylinder 621 and forms a transfer nip. The pretreatment unit 4002 may apply a reaction liquid to the intermediate transfer member 4001 to increase the viscosity of a liquid composition before the heads 101 discharge the liquid composition.

The absorption unit 4003 absorbs the liquid component from the liquid composition on the intermediate transfer member 4001 before transferring.

The heating unit 4004 heats the liquid composition on the intermediate transfer member 4001 before transferring.

Heating initializes thermal polymerization of the liquid composition, forming an insulating layer. The solvent is also removed, thereby enhancing the transferability to the substrate.

The cleaning unit 4005 cleans the intermediate transfer member 4001 after the transfer process and removes ink and contaminants, such as dust, that remain on the intermediate transfer member 4001.

The outer surface of the impression cylinder 621 is in press contact with the intermediate transfer member 4001, allowing the insulating layer on the intermediate transfer member 4001 to be transferred to the substrate when it passes through the transfer nip between the impression cylinder 621 and the intermediate transfer member 4001. The impression cylinder 621 can be configured to include at least one gripping mechanism for holding the front end of the substrate on its outer surface.

FIG. 14 is a configuration diagram (part 2) illustrating another example of a printing unit in which an inkjet method and a transfer method are adopted as the liquid composition application device in an insulating layer manufacturing device according to the present disclosure. The printing unit 14 has an intermediate transfer member having an endless belt form.

A printing unit 400″ is an inkjet printer that forms an insulating layer on a substrate by transferring the liquid composition or the insulating layer onto the substrate via an intermediate transfer belt 4006.

The printing unit 400″ is equipped with an inkjet unit 420, a transfer roller 622, the intermediate transfer belt 4006, a heating unit 4007, a cleaning roller 4008, a drive roller 4009a, a counter roller 4009b, a shape-maintaining roller 4009c, a shape-maintaining roller 4009d, a shape-maintaining roller 4009e, and a shape-maintaining roller 4009f.

The printing unit 400″ discharges liquid droplets of the liquid composition from the heads 101 of the inkjet unit 420 onto the outer surface of the intermediate transfer belt 4006. The liquid composition on the intermediate transfer belt 4006 is heated by the heating unit 4007 and forms an insulating layer through thermal polymerization. The insulating layer on the intermediate transfer belt 4006 is transferred to the substrate at the transfer nip where the intermediate transfer belt 4006 faces the transfer roller 622. After transfer, the cleaning roller 4008 cleans the surface of the intermediate transfer belt 4006.

The intermediate transfer belt 4006 is stretched over a drive roller 4009a, a counter roller 4009b, multiple shape-maintaining rollers 4009c, 4009d, 4009e, 4009f, and several support rollers 4009g, and moves in the direction indicated by the arrow in FIG. 14. The support rollers 4009g disposed facing the heads 101 maintain the tension of the intermediate transfer belt 4006 when the heads 101 discharge ink droplets.

### Electrochemical Element

The electrochemical element relating to the present disclosure preferably includes an electrode laminate, and may optionally have an outer casing as well.

Note that the electrode laminate is the same as described in the section on Electrode Laminates, so redundant descriptions are omitted.

An embodiment of the electrochemical element relating to the present disclosure is described with reference to the drawings.

The present disclosure is not limited to these embodiments.

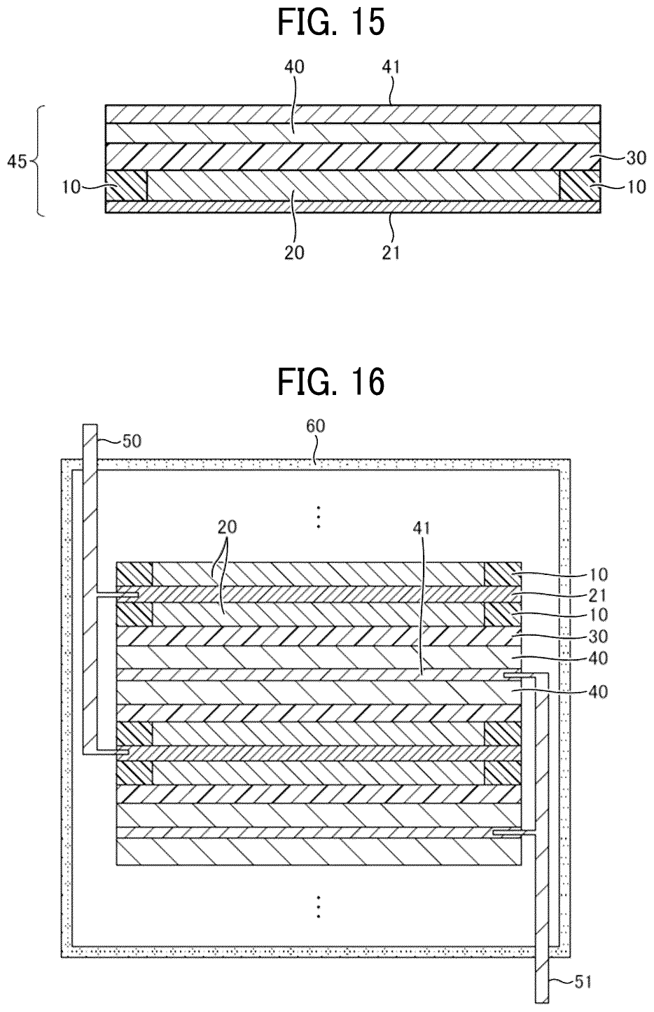

FIG. 15 is a schematic cross-sectional view illustrating the electrochemical element according to one embodiment of the present disclosure. The electrochemical element 45 includes a first substrate 21, a first electrode composite layer 20 disposed on the first substrate 21, an insulating layer 10 disposed on the outer periphery of the electrode composite layer 20, a solid electrolyte layer 30 disposed on the electrode composite layer 20 and the insulating layer 10, a second electrode composite layer 40 disposed on the solid electrolyte layer 30, and a second substrate 31 disposed on the second electrode composite layer 40. The electrochemical element 45 is a single-cell layer, and this can be laminated to form a stacked battery.

Note that FIG. 15 illustrates the configuration in which the electrode composite layer 20, the insulating layer 10, and the solid electrolyte layer 30 are provided on one side of the first substrate 21, but the electrode composite layer 20, the insulating layer 10, and the solid electrolyte layer 30 may be provided on both opposing sides of the first substrate 21. This configuration may be laminated to form a stacked battery.

FIG. 16 is a schematic cross-sectional view illustrating an example of a solid state battery, which is an electrochemical element according to one embodiment of the present disclosure.

The solid state battery illustrated in FIG. 16 includes a positive electrode (electrode composite layer) 20, a negative electrode (electrode composite layer) 40, a solid electrolyte layer 30, lead wires 50 and 51, and an outer casing 60.

The positive electrode (first electrode composite layer) 20 includes a positive electrode substrate 21 and an insulating layer 10 disposed on the positive electrode substrate 21. The lead wire 50 is connected to the positive electrode substrate 21, and the lead wire 51 is connected to the negative electrode substrate 41. The lead wires 50 and 51 are drawn out to the outside of the outer casing 60.

In the solid state battery, the positive electrode (electrode composite layer) 20 and the negative electrode (electrode composite layer) 40 are stacked via the solid electrolyte layer 30, and the positive electrode (electrode composite layer) 20 is disposed on both sides of the negative electrode (electrode composite layer) 40. Note that there is no particular limit on the number of stacks of the positive electrodes (first electrode composite layer) 20 and the negative electrodes (second electrode composite layer) 40. Also, the number of positive electrodes (first electrode composite layers) 20 and negative electrodes (second electrode composite layers) 40 may be the same or different.

As for the outer casing, there is no particular limitation as long as it can seal the electrode laminate, and a known outer casing can be appropriately selected depending on the purpose.

The shape of the electrochemical element is not particularly limited and can be appropriately selected depending on the purpose. For example, it may be a laminate type, cylinder type, or coin type.

In electrochemical devices where short circuits can potentially occur due to dendrite deposition, it is generally common to configure the negative electrode composite layer to be larger than the positive electrode composite layer. In this case, if the positive and negative current collectors are approximately the same size, a surplus area where the positive electrode composite layer is not formed will be present in the region on the positive current collector where it faces the negative electrode composite layer. In term of electrochemical element properties, it is preferable that the insulating layer be provided in the surplus area of the positive electrode, that is, at the outer periphery of the positive electrode composite layer. However, if the configuration is such that the negative electrode composite layer is smaller than the positive electrode composite layer in an electrochemical element, it is preferable that the insulating layer be provided in the surplus area of the negative electrode, that is, at the outer periphery of the negative electrode composite layer.

### Method of Manufacturing Electrochemical Element and Apparatus for Manufacturing Electrochemical Element

The method for manufacturing an electrochemical element relating to the present disclosure preferably includes an insulating layer forming process, an electrode composite layer forming process, a pressing process, a solid electrolyte layer forming process, a device forming process, and an electrode processing process, and may also include other optional processes.

The apparatus for manufacturing an electrochemical element relating to the present disclosure preferably includes an insulating layer forming device, an electrode composite layer forming device, a pressing device, a solid electrolyte layer forming device, an element forming device, and an electrode processing device, and may also include other optional devices.

Since the insulating layer forming process, insulating layer forming device, electrode composite layer forming process, electrode composite layer forming device, pressing process, pressing device, solid electrolyte layer forming process, solid electrolyte layer forming device, other processes, and other devices are the same as those described in the sections on Method of Manufacturing Electrode for Electrochemical Element and Apparatus for Manufacturing Electrode for Electrochemical Element and Method of Manufacturing Electrode Laminate and Apparatus for Manufacturing Electrode Laminate, the repetitive descriptions are omitted.

### Element Forming Process and Element Forming Device

The element forming process is for manufacturing an electrochemical element using an electrode laminate.

The element forming device is for manufacturing an electrochemical element using an electrode laminate.

There are no particular restrictions on the method of manufacturing an electrochemical element using an electrode laminate, and an appropriate, known method of manufacturing an electrochemical element may be selected according to a particular application. For example, it may include at least one of placing counter electrodes, winding or laminating, and housing in a container to form an energy storage element.

Note that the element forming process does not need to include all processes of element forming and may include only a part of the processes involved in element forming.

### Electrode Processing Process and Electrode Processing Device

The electrode processing process is for processing an electrode with a formed insulating layer, conducted after the liquid composition application process in the insulating layer forming process. The electrode processing process may include at least one of a cutting process, folding process, and laminating process.

The electrode processing device is for processing an electrode with a formed insulating layer. The electrode processing device may include at least one of a cutting device, folding device, and laminating device.

For example, the electrode processing device may cut the electrode with a formed insulating layer to create an electrode laminate. The electrode processing device may, for example, wind or laminate the electrode laminate with a formed insulating layer. The electrode processing device may, for example, include an electrode processing device that performs cutting, accordion folding, laminating, or winding of the electrode laminate with a formed insulating layer according to the desired battery format.

The application of the electrochemical device is not particularly limited and it can be suitably selected to suit to a particular application.

Examples include, but are not limited to: mobile objects such as vehicles; and electric devices, such as mobile phones, notebook computers, pen-input personal computers, mobile personal computers, electronic book players, cellular phones, portable facsimiles, portable copiers, portable printers, headphone stereos, video movies, liquid crystal televisions, handy cleaners, portable compact discs (CDs), minidiscs, transceivers, electronic notebooks, calculators, memory cards, portable tape recorders, radios, backup power supplies, motors, lighting devices, toys, game machines, watches, strobes, and cameras. Of these, vehicles and electric devices are preferable.

The mobile objects include, but are not limited to, ordinary vehicles, heavy special cars, small special vehicles, trucks, heavy motorcycles, and ordinary motorcycles.

An embodiment of the mobile object as the electrochemical element relating to the present disclosure is described with reference to the drawings. The present disclosure is not limited to these embodiments.

### Mobile Object

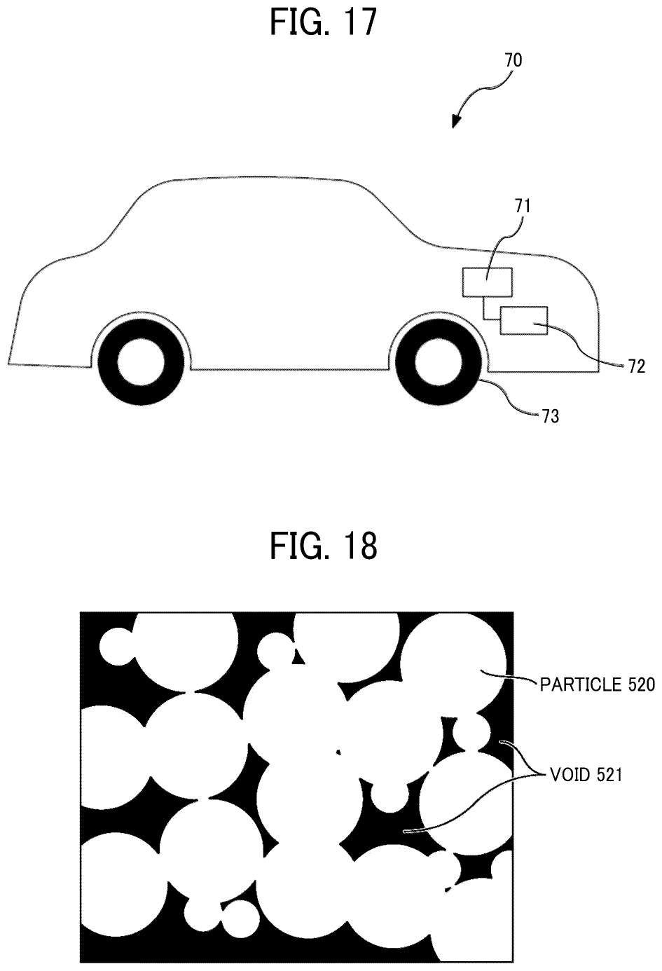

FIG. 17 is a schematic diagram illustrating a mobile object, which is an electrochemical element according to an embodiment of the present disclosure.

A mobile object 70 is an electric vehicle, for example. The mobile object 70 includes a motor 71, an electrochemical device 72, and wheels 73.

The electrochemical device 72 is an electrochemical device relating to the present disclosure. The electrochemical device 72 drives a motor 71 by supplying electricity to the motor 71. The motor 71 driven can drive the wheels 73, and as a result, the mobile object 70 can move.

Since the mobile object 70 is equipped with the electrochemical device 72, it prevents short circuits between the positive and negative electrodes, and is driven by the power from an electrochemical device that has excellent battery properties, allowing the vehicle to move safely and efficiently.

The mobile object 70 is not limited to an electric vehicle; it may be a plug-in hybrid vehicle (PHEV), a hybrid electric vehicle (HEV), and a locomotive or motorcycle that can operate using both a diesel engine and an electrochemical element. Additionally, the mobile object 70 could be a transport robot used in factories, capable of operating with only an electrochemical element or in combination with an engine and an electrochemical element. Furthermore, the mobile object 70 could be a device where not the entire object moves, but only a part of it, such as an assembly robot placed in a factory production line, which can operate using only an electrochemical element or in combination with an engine and an electrochemical element to move an arm or other components.

### Substrate

The substrate is not particularly limited as long as it has electronic conductivity and is stable with respect to the applied potential. It can be appropriately selected according to a particular application. Examples include, but are not limited to, aluminum foil, copper foil, stainless steel foil, titanium foil, etched foil with fine holes created by etching such foil, carbon-coated foil with a surface layer coated with a carbon-containing resin layer, foil coated with a PTC (phase-transfer catalyst) layer, and perforated substrates used in lithium-ion capacitors.

In the present specification, the substrate used for the negative electrode may be referred to as a “negative electrode substrate” or a “substrate for a negative electrode,” while the substrate used for the positive electrode may be referred to as a “positive electrode substrate” or a “substrate for a positive electrode.”

The substrate is a highly conductive material, with aluminum used for the positive electrode substrate and copper used for the negative electrode substrate. However, the substrates according to the present embodiment are not limited to these materials.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis 1: Synthesis of Inorganic Solid Electrolyte 1

n inorganic solid electrolyte 1, Li₆PS₅Cl (LPSC), an argyrodite-type sulfide solid electrolyte, was synthesized according to Literature 1 (Nataly Carolina Rosero-Navarro et al., Journal of Power Sources 396 (2018) 33).

### Preparation of Liquid Composition for Forming Solid Electrolyte Layer

A total of 50.5 percent by mass of p-cymene (available from Kanto Chemical Co., Inc.) as a dispersing medium was added to 45 percent by mass of the inorganic solid electrolyte 1 (average particle diameter D50: approximately 0.6 μm) as a solid electrolyte and 4.5 percent by mass of Solsperse 3000 (available from The Lubrizol Corporation) as a dispersant. The mixture obtained was dispersed using a high-speed homogenizer (MT3100S2, available from Kinematica AG) at 30,000 rpm for 1 hour to obtain a liquid composition for forming a solid electrolyte layer.

### Preparation of Liquid Composition for Forming Electrode Composite Layer

A total of 50 percent by mass of a nickel-based positive electrode active material (NCA, available from JFE MINERAL & ALLOY Co., LTD.) as an active material was pulverized and disaggregated in ethyl lactate containing 0.5 percent by mass of SC-0708A (available from NOF Corporation) as a dispersant, using a bead mill to disperse it in ethyl lactate.

Subsequently, 1.5 percent by mass of carbon black (available from Denka Co., Ltd.) and 1.5 percent by mass of a polyamide-imide compound (PAI) represented by the Chemical Formula 1 below were further mixed into the dispersion to obtain a liquid composition for forming the electrode composite layer. The resulting liquid composition for forming the electrode composite layer exhibited a mode diameter of the active material particles of 9.72 μm and a viscosity of 10.7 mPa·s at 25 degrees Celsius.

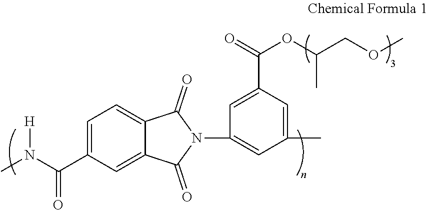

### Example 1

### Formation of Electrode Composite Layer

An aluminum foil (available from UACJ Corporation) as a substrate was coated with the liquid composition for forming the electrode composite layer using an inkjet device (Model: EV1000). The coating was then heated and dried at 80 degrees Celsius to form the electrode composite layer.

For the formed electrode composite layer, the surface roughness difference and porosity difference were measured as described below. The surface roughness difference was found to be greater than 0 μm but less than 1 μm, and the porosity difference was 1 percent.

### Method of Measuring Surface Roughness Difference

The surface roughness difference of the electrode composite layer was measured using a laser microscope, based on the surface profile. As illustrated in FIG. 2A, the highest position was considered the convex portion, and the lowest position was considered the concave portion.

### Method of Measuring Porosity Difference

A main agent (Lot No. 53512040149, available from SANKEI CO., LTD.) of 53-type embedding epoxy resin and a curing agent (Lot No. 53572040342, available from SANKEI CO., LTD.) were thoroughly mixed in a volume ratio at 1:2. The mixture was used to embed the electrode composite layer in resin under vacuum conditions using a vacuum impregnation device (BÜHLER VACUUM IMPREGNATION EQUIPMENT I, available from SANKEI CO., LTD.) and was cured for 24 hours. The resin-embedded electrode composite layer was processed using a cross-section polisher (available from JEOL Ltd.), and its cross-section was observed using a tabletop scanning electron microscope SEM (Phenom ProX, available from Jasco International Co., Ltd.), where SEM images of the electrode composite layer were captured.

The SEM images captured were binarized using image processing software (Image-Pro Premier version 9.2 64-bit, available from Hakuto Co., Ltd.), as illustrated in FIG. 18. The areas corresponding to particles and voids were determined, and the area of voids was divided by the entire area to calculate the porosity of the convex portions and non-convex portions. In this method, although binarization was performed using software, for example, in a binarized image, regions with a density higher than 50 percent could be considered particles or voids, while regions with a density of 50 percent or less could be judged as voids or particles. In FIG. 18, the white regions represent particles 520 while the black regions represent void areas 521.

### Formation of Solid Electrolyte Layer

The liquid composition for forming the solid electrolyte layer was applied onto the electrode composite layer using an inkjet device (Model: EV1000) in a single application with an application amount of 5.1 mg/cm². The coating was then heated and dried at 80 degrees Celsius to form a solid electrolyte layer, thereby producing an electrode 1 for an electrochemical element.

For the formed solid electrolyte layer, the film thickness of the convex portions and concave portions was measured as described below. The film thickness of the convex portions (A) (hereinafter referred to as “SE thickness (A)”) was 15 μm, the film thickness of the concave portions (B) (hereinafter referred to as “SE thickness (B)”) was 15 μm, and the thickness ratio (A/B) was 1. Additionally, the application amount of the liquid composition for forming the solid electrolyte layer was measured as described below, and the single application amount was 5.1 mg/cm².

### Method of Measuring SE Thickness (A) and SE Thickness (B)

The solid electrolyte layer was processed using CP at 6 kV for 2 hours to create a cross-section, which was then observed using SEM. The distance from the electrode surface to the surface of the solid electrolyte layer in the vertical direction of the metal foil was measured at 0.5 mm intervals to determine the SE thickness (A) and SE thickness (B).

### Method of Measuring Single Application Amount

The liquid composition for forming the solid electrolyte layer, which had been applied, was recovered and weighed using an electronic balance (UX6200H).

### Example 2

The electrode 2 for an electrochemical element was produced in the same manner as in Example 1 except that the electrode composite layer was formed such that the surface roughness difference of the electrode composite layer was 15 μm.

### Example 3

The electrode 3 for an electrochemical element was produced in the same manner as in Example 2 except that the electrode composite layer was formed such that the porosity difference of the electrode composite layer was 13 percent, and a second coating was applied at a single coating amount of 5.45 mg/cm² after the first coating of the liquid composition for forming the solid electrolyte layer at a single coating amount of 5.45 mg/cm² with a sufficient interval between the first coating and the second coating.

### Example 4

The electrode 4 for an electrochemical element was produced in the same manner as in Example 2 except that an electrode composite layer was formed such that the surface roughness difference was 10 μm and the porosity difference was 4.5 percent, and a second coating was applied at a single coating amount of 0.34 mg/cm² after the first coating of the liquid composition for forming the solid electrolyte layer at a single coating amount of 8 mg/cm² with a sufficient interval between the first coating and the second coating.

### Example 5

The electrode 5 for the electrochemical element was produced in the same manner as in Example 2 except that an electrode composite layer was formed such that the surface roughness difference was 5 μm, and the porosity difference was 5 percent, and the liquid composition for forming the solid electrolyte layer was applied in a single coating with an application amount of 10 mg/cm².

### Example 6

The electrode 6 for the electrochemical element was produced in the same manner as in Example 2 except that an electrode composite layer was formed such that the surface roughness difference was 20 μm, and the porosity difference was 3 percent, and the liquid composition for forming the solid electrolyte layer was applied in a single coating with an application amount of 9.2 mg/cm².

### Example 7

The electrode 7 for an electrochemical element was produced in the same manner as in Example 2 except that an electrode composite layer was formed such that the surface roughness difference was 20 μm and the porosity difference was 9.8 percent, and a second coating was applied at a single coating amount of 4.6 mg/cm² after the first coating of the liquid composition for forming the solid electrolyte layer at a single coating amount of 4.6 mg/cm² with a sufficient interval between the first coating and the second coating.

### Example 8

The electrode 8 for the electrochemical element was produced in the same manner as in Example 2 except that an electrode composite layer was formed such that the surface roughness difference was 6 μm and the porosity difference was 5 percent, a positive electrode insulation frame was provided around the perimeter of the electrode composite layer, and the liquid composition for forming the solid electrolyte layer was applied in a single coating with an application amount of 6.8 mg/cm².

### Example 9

The electrode 9 for an electrochemical element was produced in the same manner as in Example 6 except that an electrode composite layer was formed such that the porosity difference was 11 percent.

### Example 10

The electrode 10 for an electrochemical element was produced in the same manner as in Example 1 except that the liquid composition for forming a solid electrolyte layer was applied once with an application amount of 0.34 mg/cm² to form a solid electrolyte layer.

### Example 11

The electrode 11 for an electrochemical element was produced in the same manner as in Example 1 except that the liquid composition for forming a solid electrolyte layer was applied once with an application amount of 10 mg/cm² to form a solid electrolyte layer.

### Comparative Example 1

The electrode 12 for an electrochemical element was produced in the same manner as in Example 2 except that the liquid composition for forming a solid electrolyte layer was applied by spin coating to form a solid electrolyte layer.

### Comparative Example 2

The electrode 13 for the electrochemical element was produced in the same manner as in Example 2 except that an electrode composite layer was formed such that the surface roughness difference was 20 μm, and the liquid composition for forming the solid electrolyte layer was applied in a single coating with an application amount of 11 mg/cm².

### Comparative Example 3

The electrode 14 for an electrochemical element was produced in the same manner as in Example 3 except that the electrode composite layer was formed such that the porosity difference of the electrode composite layer was 8 percent, and a second coating was applied at a single coating amount of 12 mg/cm² after the first coating of the liquid composition for forming the solid electrolyte layer at a single coating amount of 3 mg/cm² with a sufficient interval between the first coating and the second coating.

### Comparative Example 4

The electrode 15 for an electrochemical element was produced in the same manner as in Example 1 except that the liquid composition for forming a solid electrolyte layer was applied once with an application amount of 0.32 mg/cm² to form a solid electrolyte layer.

The electrodes 1 to 15 for electrochemical elements obtained in Examples 1 to 11 and Comparative Examples 1 to 4 were evaluated for input-output properties based on the criteria below. The evaluation results are shown in Table 1.

### Input-Output Properties

Evaluation cells for all-solid-state lithium secondary batteries, incorporating each of the electrodes for its corresponding electrochemical element, were subjected to charge-discharge testing using a charge-discharge testing system (TOSCAT-3100, available from TOYO SYSTEM CO., LTD.). The test was conducted in a thermostatic chamber at 25 degrees Celsius over a voltage range of 3.7 V to 2.4 V. The discharge capacity at 1.0 C and 0.1 C was measured under discharge (output) and charge (input) conditions. The capacity retention rate was calculated according to Equation 1 below, and input-output properties were evaluated based on the criteria described below. The results are shown in Table 1. In all Examples and Comparative Examples, the capacity retention rates under discharge (output) and charge (input) conditions were identical.

Capacity retention rate=1.0 C discharge capacity/0.1 C discharge capacity Equation 1

### Evaluation Criteria

A: 70 percent≤Capacity retention rate
B: 50 percent≤Capacity retention rate<70 percent
C: Capacity retention rate<50 percent

TABLE 1

| Formation of electrode composite | |
|---|---|
| layer | |
| | Physical properties of |
| | electrode composite |
| | layer |

| | Electrode | | Surface | |
|---|---|---|---|---|
| | containing | | roughness | Porosity |
| | solid | Method of | difference | difference |
| | electrolyte | application | (μm) | (percent) |
| Example 1 | 1 | Inkjet | <1 | <1.0 |
| Example 2 | 2 | Inkjet | 15 | <1.0 |
| Example 3 | 3 | Inkjet | 15 | 13.1 |
| Example 4 | 4 | Inkjet | 10 | 4.5 |
| Example 5 | 5 | Inkjet | 5 | 4.9 |
| Example 6 | 6 | Inkjet | 20 | 3.0 |
| Example 7 | 7 | Inkjet | 20 | 9.8 |
| Example 8 | 8 | Inkjet | 6 | 5.2 |
| Example 9 | 9 | Inkjet | 20 | 11.4 |
| Example 10 | 10 | Inkjet | <1 | <1.0 |
| Example 11 | 11 | Inkjet | <1 | <1.0 |
| Comparative | 12 | Inkjet | 15 | <1.0 |
| Example 1 | | | | |
| Comparative | 13 | Inkjet | 20 | <1.0 |
| Example 2 | | | | |
| Comparative | 14 | Inkjet | 15 | 8.2 |
| Example 3 | | | | |
| Comparative | 15 | Inkjet | <1 | <1.0 |
| Example 4 | | | | |

| | Formation of solid electrolyte layer | | | | | | |
|---|---|---|---|---|---|---|---|
| | | | | Physical properties of solid | | | |
| | | First | Second | electrolyte layer | | | |
| | | application | application | SE | SE | Thickness | |
| | Method of | amount | amount | thickness | thickness | ratio | Input-output |
| | application | (mg/cm²) | (mg/cm²) | (A) (μm) | (B) (μm) | (A/B) | properties |
| Example 1 | Inkjet | 5.10 | — | 14.6 | 15.4 | 0.95 | B |
| Example 2 | Inkjet | 5.10 | — | 15.3 | 14.9 | 1.03 | A |
| Example 3 | Inkjet | 5.45 | 5.45 | 34.8 | 31.3 | 1.11 | B |
| Example 4 | Inkjet | 8.00 | 0.34 | 25.1 | 24.7 | 1.02 | A |
| Example 5 | Inkjet | 10.00 | — | 29.5 | 25.6 | 1.15 | A |
| Example 6 | Inkjet | 9.20 | — | 27.0 | 26.6 | 1.02 | A |
| Example 7 | Inkjet | 4.60 | 4.60 | 29.2 | 25.2 | 1.16 | A |
| Example 8 | Inkjet | 6.80 | — | 20.1 | 20.3 | 0.99 | A |
| Example 9 | Inkjet | 9.20 | — | 33.1 | 28.3 | 1.17 | B |
| Example 10 | Inkjet | 0.34 | — | 1.0 | 1.0 | 1.00 | B |
| Example 11 | Inkjet | 10.00 | — | 30.3 | 29.6 | 1.02 | B |
| Comparative | Spin | 5.10 | — | 15.1 | 4.9 | 3.08 | C |
| Example 1 | coating | | — | | | | |
| Comparative | Inkjet | 11.00 | — | 32.1 | 11.8 | 2.72 | C |
| Example 2 | | | — | | | | |
| Comparative | Inkjet | 3.00 | 12.00 | 28.7 | 44.4 | 0.65 | C |
| Example 3 | | | | | | | |
| Comparative | Inkjet | 0.32 | — | <1 | <1 | — | C |
| Example 4 | | | | | | | |

Aspects of the embodiments of the present invention are, for example, as follows:

### Aspect 1

A method of manufacturing an electrode for an electrochemical element includes applying a first liquid composition onto an electrode composite layer having a rough structure by inkjetting in an amount of 0.34 to 10 mg/cm² per application to form a first solid electrolyte layer comprising a solid electrolyte, to manufacture the electrode including a substrate, the electrode composite layer disposed on the substrate, containing an active material, and the first solid electrolyte layer, wherein the liquid composition contain the solid electrolyte and a dispersion medium and has a viscosity of 4 to 20 mPa·s.

### Aspect 2

The method according to Aspect 1 mentioned above, wherein the solid electrolyte layer has an average thickness of 2 to 40 μm.

### Aspect 3

The method according to Aspect 1 or 2 mentioned above, wherein the rough structure has a surface having a height difference of at least 5 μm.

### Aspect 4

The method according to any one of Aspects 1 to 3 mentioned above, wherein the electrode composite layer has a porosity difference of 0 to 10 percent.

### Aspect 5

The method according to any one of Aspects 1 to 4 mentioned above, wherein an insulating layer is disposed on an outer periphery of the electrode composite layer.

### Aspect 6

The method according to any one of Aspects 1 to 5 mentioned above further includes applying an electrode composite layer forming composition containing the active material onto the substrate by inkjetting to form the electrode composite layer.

### Aspect 7

The method according to any one of Aspects 1 to 6 mentioned above further includes repeating the applying the first liquid composition by inkjetting to form a laminate structure of solid electrolyte layers having at least two layers of the solid electrolyte layer.

### Aspect 8

The method according to any one of Aspects 1 to 7 mentioned above further includes applying another liquid composition comprising another solid electrolyte different from the solid electrolyte onto the solid electrolyte layer to form another solid electrolyte layer on the solid electrolyte layer.

### Aspect 9

An electrode for an electrochemical element includes an electrode including a substrate and an electrode composite layer on the substrate, the electrode composite layer including an active material and a solid electrolyte layer on the electrode composite layer, wherein the electrode composite layer has a convex portion with at least 5 μm, and the solid electrolyte layer has a ratio (A/B) of 0.8 to 1.2, where A represents the average thickness of the convex portion of the solid electrolyte layer and B represents the average thickness of the concave portion of the solid electrolyte layer.

### Aspect 10

The electrode according to Aspect 9, mentioned above, wherein the electrode composite layer has a porosity difference of 0 to 10 percent.

### Aspect 11

The electrode according to Aspect 9 or 10 mentioned above, wherein an insulating layer is disposed on the outer periphery of the electrode composite layer.

### Aspect 12

An electrochemical element includes the electrode of any one of Aspects 9 to 11 mentioned above.

### Aspect 13

An electric device includes the electrochemical element of Aspect 12 mentioned above.

### Aspect 14

A mobile object includes the solid state electrochemical element of Aspect 12 mentioned above.

### Aspect 15

The mobile object according to Aspect 14 mentioned above includes a vehicle.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A method of manufacturing an electrode for an electrochemical element comprising:
applying a first liquid composition onto an electrode composite layer having a rough structure by inkjetting in an amount of 0.34 to 10 mg/cm² per application to form a first solid electrolyte layer comprising a solid electrolyte, to manufacture the electrode comprising:
a substrate;
the electrode composite layer disposed on the substrate, comprising an active material; and
the first solid electrolyte layer,
wherein the liquid composition comprises the solid electrolyte and a dispersion medium and has a viscosity of 4 to 20 mPa·s.

2. The method according to claim 1,
wherein the solid electrolyte layer has an average thickness of 2 to 40 μm.

3. The method according to claim 1,
wherein the rough structure has a surface having a height difference of at least 5 μm.

4. The method according to claim 1,
wherein the electrode composite layer has a porosity difference of 0 to 10 percent.

5. The method according to claim 1,
wherein an insulating layer is disposed on an outer periphery of the electrode composite layer.

6. The method according to claim 1,
further comprising applying an electrode composite layer forming composition containing the active material onto the substrate by inkjetting to form the electrode composite layer.

7. The method according to claim 1,
further comprising repeating the applying the first liquid composition by inkjetting to form a laminate structure of solid electrolyte layers having at least two layers of the solid electrolyte layer.

8. The method according to claim 1,
further comprising applying another liquid composition comprising another solid electrolyte different from the solid electrolyte onto the solid electrolyte layer to form another solid electrolyte layer on the solid electrolyte layer.

9. An electrode for an electrochemical element comprising:
an electrode comprising:
a substrate; and
an electrode composite layer on the substrate, the electrode composite layer comprising an active material; and
a solid electrolyte layer on the electrode composite layer,
wherein the electrode composite layer has a convex portion with at least 5 μm, and
the solid electrolyte layer has a ratio (A/B) of 0.8 to 1.2, where A represents an average thickness of a convex portion of the solid electrolyte layer and an average thickness of a concave portion of the solid electrolyte layer.

10. The electrode according to claim 9,
wherein the electrode composite layer has a porosity difference of 0 to 10 percent.

11. The electrode according to claim 9,
wherein an insulating layer is disposed on an outer periphery of the electrode composite layer.

12. An electrochemical element comprising:
the electrode of claim 9.

13. An electric device comprising the electrochemical element of claim 12.

14. A mobile object comprising the electrochemical element of claim 12.

15. The mobile object according to claim 14, comprising a vehicle.
